(19) United States
(12) Patent Application Publication
(10) Pub. No.: US 2026/0247466 A1
(43) Pub. Date: Aug. 20, 2026

(54) Multi-Link Triggered Transmission Opportunity Sharing (TXS)-based Relaying

(71) Applicant: Ofinno, LLC, Reston, VA (US)

(72) Inventors: Tuncer Baykas, Reston, VA (US); Jeongki Kim, Fairfax, VA (US); Esmael Hejazi Dinan, McLean, VA (US); Serhat Erkucuk, Reston, VA (US); Leonardo Alisasis Lanante, Reston, VA (US)

(73) Assignee: Ofinno, LLC, Reston, VA (US)

(21) Appl. No.: 19/645,646

(22) Filed: Apr. 13, 2026

Related U.S. Application Data
(63) Continuation of application No. PCT/US2024/050722, filed on Oct. 10, 2024.
(60) Provisional application No. 63/543,958, filed on Oct. 13, 2023.

(51) Int. Cl. H04W 76/15; H04W 88/04

(52) U.S. Cl. CPC H04W 76/15; H04W 88/04

(57) ABSTRACT

In an aspect, a first access point (AP) transmits, via a first link to a first station (STA), a first frame including: a first field indicating relaying, by the first STA to a second STA, of one or more frames received from the AP, and a second field indicating a second link for relaying the one or more frames from the first STA to the second STA. The AP transmits to the first STA the one or more frames via the first link. In another aspect a first STA receives, from an AP via a first link, a first frame comprising: a first field indicating relaying, by the first STA to a second STA, of one or more frames received from the AP, and a second field indicating a second link for the relaying of the one or more frames from the first STA to the second STA.

### CROSS-REFERENCE TO RELATED APPLICATIONS

This application is a continuation of International Application No. PCT/US2024/050722, filed Oct. 10, 2024, which claims the benefit of U.S. Provisional Application No. 63/543,958, filed Oct. 13, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of a Medium Access Control (MAC) frame format.

FIG. 4 illustrates an example of a Quality of Service (QoS) null frame indicating buffer status information.

FIG. 5 illustrates an example format of a physical layer (PHY) protocol data unit (PPDU).

FIG. 6 illustrates an example that includes buffer status reporting by STAs, scheduling by an AP of uplink multi-user (MU) transmissions, and transmission of scheduled uplink transmissions by the STAs.

FIG. 7 illustrates an example reference model for a multi-link device (MLD).

FIG. 8 illustrates an example of an AP MLD and an associated non-AP MLD.

FIG. 9 illustrates an example of a multi-link setup between an AP MLD and a non-AP MLD.

FIG. 10 illustrates an example of a traffic identifier (TID)-to-link mapping in a multi-link communication environment.

FIG. 11 illustrates an example of a sub-1 GHz (S1G) relay architecture.

FIG. 12 illustrates an example of source-relay-destination link.

FIG. 13 is an example that illustrates relaying with no transmission opportunity (TXOP) protection.

FIG. 14 illustrates an example of Request-to-Send (RTS)/Clear-to-Send (CTS) procedure.

FIG. 15 is an example that illustrates relaying with TXOP protection.

FIG. 16 is an example diagram of a Multi-User Request-to-Send (MU-RTS) trigger frame which may be used in a triggered Transmission Opportunity (TXOP) sharing (TXS) procedure.

FIG. 17 illustrates an example of a common info field of an MRTT frame which may be used in a TXS procedure according to an embodiment.

FIG. 18 illustrates an example of a triggered TXS procedure (Mode=1).

FIG. 19 illustrates an example of a triggered TXS procedure (Mode=2).

FIG. 20 illustrates an example of a TXS procedure for allocating time within an obtained TXOP to multiple STAs, with a respective triggered TXOP sharing mode indicated per STA.

FIG. 21 illustrates an example of a TXS-based relaying procedure, which may be used for relaying downlink traffic from an AP to a STA.

FIG. 22 illustrates a problem that may arise in the TXS-based procedure of FIG. 21.

FIG. 23 illustrates an example of a multi-link relaying procedure, which may be used for relaying downlink traffic from an AP to a STA according to an embodiment.

FIG. 24 illustrates an example of a multi-link relaying procedure, which may be used for relaying downlink traffic from an AP to a STA according to an embodiment.

FIG. 25 illustrates another example of a multi-link relaying procedure, which may be used for relaying downlink traffic from an AP to a STA according to an embodiment.

FIG. 26 illustrates another example of a multi-link relaying procedure, which may be used for relaying downlink traffic from an AP to a STA according to an embodiment.

FIG. 27 illustrates another example of a multi-link relaying procedure, which may be used for relaying downlink traffic from an AP to a STA according to an embodiment.

FIG. 28 illustrates an example of a multi-link relaying procedure, which may be used for relaying uplink traffic from a STA to an AP according to an embodiment.

FIG. 29 illustrates another example of a multi-link relaying procedure, which may be used for relaying uplink traffic from a STA to an AP according to an embodiment.

FIG. 30 illustrates another example of a multi-link relaying procedure, which may be used for relaying uplink traffic from a STA to an AP according to an embodiment.

FIG. 31 illustrates an example process according to an embodiment.

FIG. 32 illustrates another example process according to an embodiment.

FIG. 33 illustrates another example process according to an embodiment.

FIG. 34 illustrates another example process according to an embodiment.

FIG. 35 illustrates another example process according to an embodiment.

FIG. 36 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

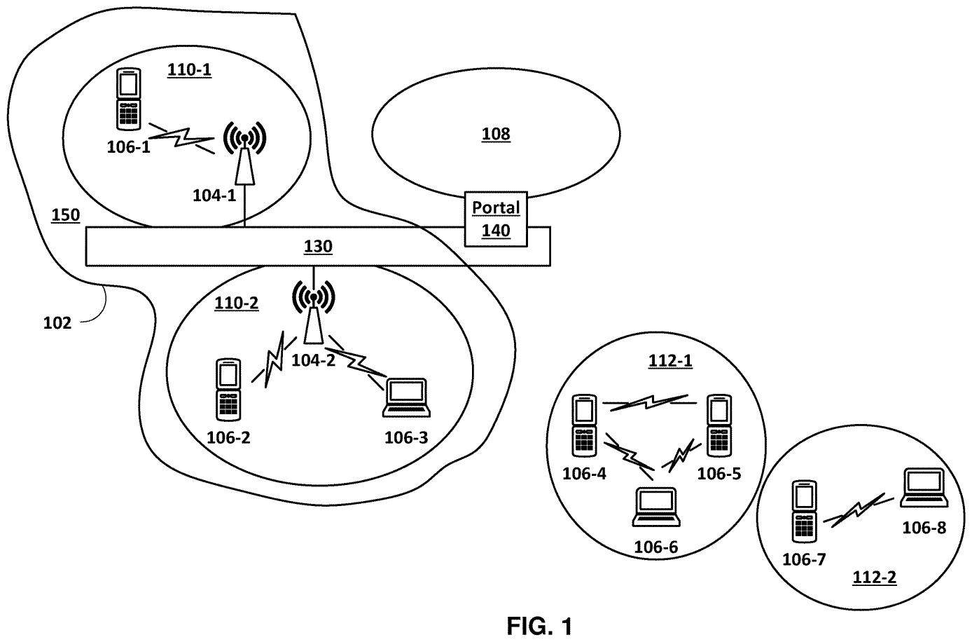

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PLCP service data unit (PSDU). For example, the PSDU may include a PHY Convergence Protocol (PLCP) preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 520 MHz by bonding together multiple 20 MHz channels.

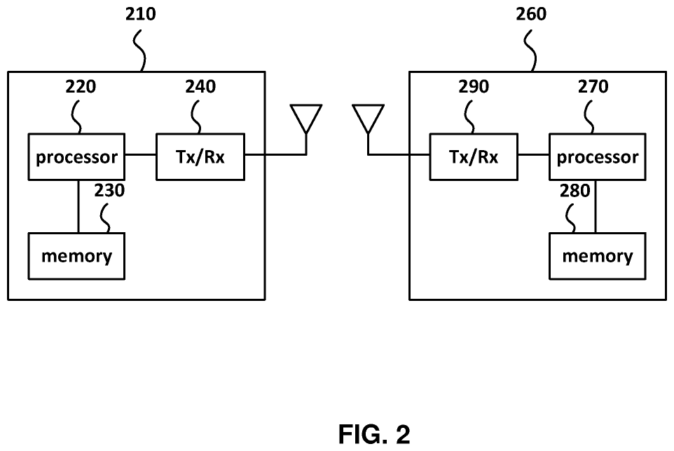

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

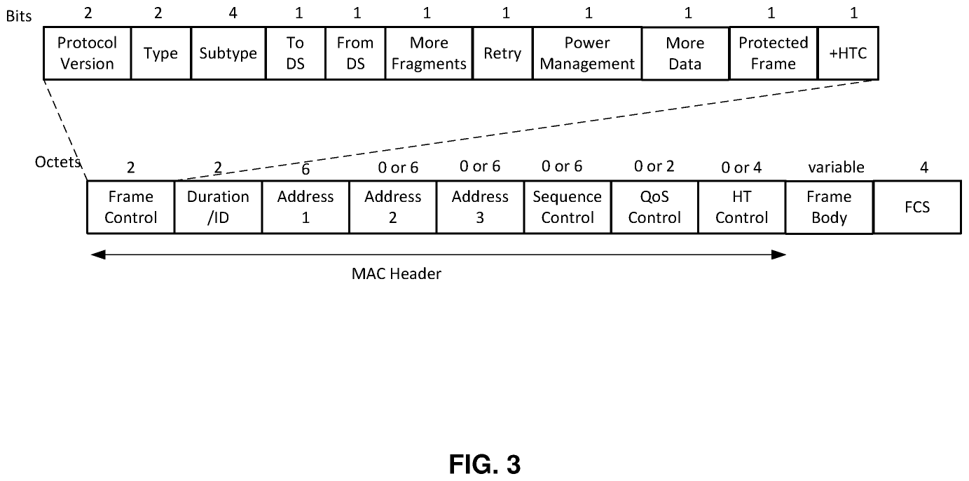

FIG. 3 illustrates an example format of a MAC frame. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, a MAC frame includes a MAC header, a variable length frame body, and a frame check sequence (FCS).

The MAC header includes a frame control field, an optional duration/ID field, address fields, an optional sequence control field, an optional QoS control field, and an optional HT control field.

The frame control field includes the following subfields: protocol version, type, subtype, “To DS”, “From DS”, “More Fragments”, retry, power management, “More Data, protected frame, and +HTC.

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS data frame, which is a data frame that contains a QoS control field in its MAC header. The second MSB of the subtype field, bit 6 (B6) of the frame control field, when set to 1 in data subtypes, indicates a data frame that contain no frame body field.

The “To DS” subfield indicates whether a data frame is destined to the distribution system (DS). The “From DS” subfield indicates whether a data frame originates from the DS.

The “More Fragments” subfield is set to 1 in all data or management frames that have another fragment to follow the MAC service data unit (MSDU), or MAC management protocol data unit (MMPDU) carried by the MAC frame. The “More Fragments” subfield is set to 0 in all other frames in which the “More Fragments” subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The “More Data” subfield indicates to a STA in power save (PS) mode that bufferable units (BUs) are buffered for that STA at the AP. The “More Data” subfield is valid in individually addressed data or management frames transmitted by an AP to a STA in PS mode. The “More Data” subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that the MAC frame contains an HT control field.

The duration/ID field of the MAC header indicates various contents depending on the frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), with the 2 most significant bits (MSB) set to 1. In other frames sent by STAs, the duration/ID field contains a duration value (in microseconds) which is used by a recipient to update a network allocation vector (NAV). The NAV is a counter that indicates to a STA an amount of time during which the STA must defer from accessing the shared medium.

Up to four address fields may be present in the MAC frame format. The address fields are used to indicate the basic service set identifier (BSSID), source address (SA), destination address (DA), transmitting address (TA), and receiving address (RA). Certain frames may not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which the MAC frame belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field.

The frame body field is a variable length field that contains information specific to individual frame types and subtypes. The frame body may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

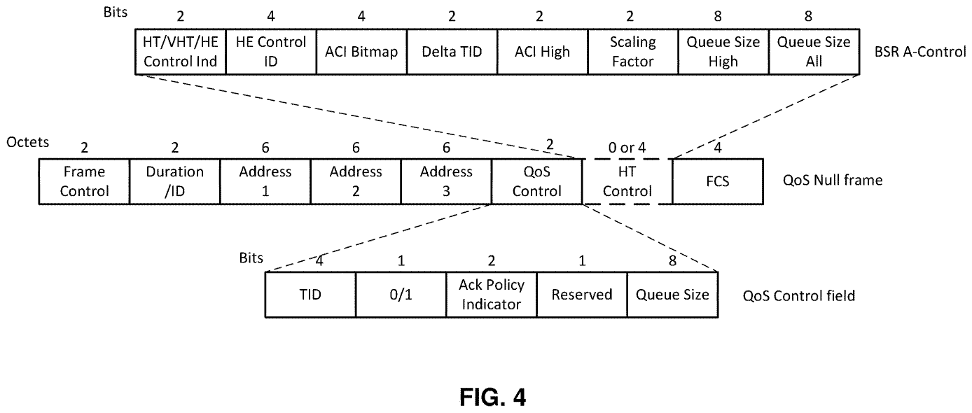

FIG. 4 illustrates an example of a QoS null frame indicating buffer status information. A QoS null frame refers to a QoS data frame with an empty frame body. A QoS null frame includes a QoS control field and an optional HT control field which may contain a buffer status report (BSR) control subfield. A QoS null frame indicating buffer status information may be transmitted by a STA to an AP.

The QoS control field may include a traffic identifier (TID) subfield, an ack policy indicator subfield, and a queue size subfield (or a transmission opportunity (TXOP) duration requested subfield).

The TID subfield identifies the TC or TS of traffic for which a TXOP is being requested, through the setting of the TXOP duration requested or queue size subfield. The encoding of the TID subfield depends on the access policy (e.g., Allowed value 0 to 7 for enhanced distributed channel access (EDCA) access policy to identify user priority for either TC or TS).

The ack policy indicator subfield, together with other information, identifies the acknowledgment policy followed upon delivery of the MPDU (e.g., normal ack, implicit block ack request, no ack, block ack, etc.)

The queue size subfield is an 8-bit field that indicates the amount of buffered traffic for a given TC or TS at the STA for transmission to the AP identified by the receiver address of the frame containing the subfield. The queue size subfield is present in QoS null frames sent by a STA when bit 4 of the QoS control field is set to 1. The AP may use information contained in the queue size subfield to determine t TXOP duration assigned to the STA or to determine the uplink (UL) resources assigned to the STA.

In a frame sent by or to a non-High Efficiency (non-HE) STA, the following rules may apply to the queue size value:
The queue size value is the approximate total size, rounded up to the nearest multiple of 256 octets and expressed in units of 256 octets, of all MSDUs and A-MSDUs buffered at the STA (excluding the MSDU or A-MSDU contained in the present QoS Data frame) in the delivery queue used for MSDUs and A-MSDUs with TID values equal to the value indicated in the TID subfield of the QoS Control field.
A queue size value of 0 is used solely to indicate the absence of any buffered traffic in the queue used for the specified TID.
A queue size value of 254 is used for all sizes greater than 64 768 octets.
A queue size value of 255 is used to indicate an unspecified or unknown size.

In a frame sent by an HE STA to an HE AP, the following rules may apply to the queue size value.

The queue size value, QS, is the approximate total size in octets, of all MSDUs and A-MSDUs buffered at the STA (including the MSDUs or A-MSDUs contained in the same PSDU as the frame containing the queue size subfield) in the delivery queue used for MSDUs and A-MSDUs with TID values equal to the value indicated in the TID subfield of the QoS control field.

The queue size subfield includes a scaling factor subfield in bits B14-B15 of the QoS control field and an unscaled value, UV, in bits B8-B13 of the QoS control field. The scaling factor subfield provides the scaling factor, SF.

A STA obtains the queue size, QS, from a received QoS control field, which contains a scaling factor, SF, and an unscaled value, UV, as follows:
QS=
16×UV, if SF is equal to 0;
1024+256×UV, if SF is equal to 1;
17 408+2048×UV, if SF is equal to 2;
148 480+32 768×UV, if SF is equal to 3 and UV is less than 62;
>2 147 328, if SF equal to is 3 and UV is equal to 62;
Unspecified or Unknown, if SF is equal to 3 and UV is equal to 63.

The TXOP duration requested subfield, which may be included instead of the queue size subfield, indicates the duration, in units of 32 microseconds (us), that the sending STA determines it needs for its next TXOP for the specified TID. The TXOP duration requested subfield is set to 0 to indicate that no TXOP is requested for the specified TID in the current service period (SP). The TXOP duration requested subfield is set to a nonzero value to indicate a requested TXOP duration in the range of 32 us to 8160 us in increments of 32 us.

The HT control field may include a BSR control subfield which may contain buffer status information used for UL MU operation. The BSR control subfield may be formed from an access category index (ACI) bitmap subfield, a delta TID subfield, an ACI high subfield, a scaling factor subfield, a queue size high subfield, and a queue size all subfield of the HT control field.

The ACI bitmap subfield indicates the access categories (ACs) for which buffer status is reported (e.g., B0: best effort (AC_BE), B1: background (AC_BK), B2: video (AC_VI), B3: voice (AC_VO), etc.). Each bit of the ACI bitmap subfield is set to 1 to indicate that the buffer status of the corresponding AC is included in the queue size all subfield, and set to 0 otherwise, except that if the ACI bitmap subfield is 0 and the delta TID subfield is 3, then the buffer status of all 8 TIDs is included.

The delta TID subfield, together with the values of the ACI bitmap subfield, indicate the number of TIDs for which the STA is reporting the buffer status.

The ACI high subfield indicates the ACI of the AC for which the BSR is indicated in the queue size high subfield. The ACI to AC mapping is defined as ACI value 0 mapping to AC_BE, ACI value 1 mapping to AC_BK, ACI value 2 mapping to AC_VI, and ACI value 3 mapping to AC_VO.

The scaling factor subfield indicates the unit SF, in octets, of the queue size high and queue size all subfields.

The queue size high subfield indicates the amount of buffered traffic, in units of SF octets, for the AC identified by the ACI high subfield, that is intended for the STA identified by the receiver address of the frame containing the BSR control subfield.

The queue size all subfield indicates the amount of buffered traffic, in units of SF octets, for all ACs identified by the ACI Bitmap subfield, that is intended for the STA identified by the receiver address of the frame containing the BSR control subfield.

The queue size values in the queue size high and queue size all subfields are the total sizes, rounded up to the nearest multiple of SF octets, of all MSDUs and A-MSDUs buffered at the STA (including the MSDUs or A-MSDUs contained in the same PSDU as the frame containing the BSR control subfield) in delivery queues used for MSDUs and A-MSDUs associated with AC(s) that are specified in the ACI high and ACI bitmap subfields, respectively.

A queue size value of 254 in the queue size high and queue size all subfields indicates that the amount of buffered traffic is greater than 254×SF octets. A queue size value of 255 in the queue size high and queue size all subfields indicates that the amount of buffered traffic is an unspecified or unknown size. The queue size value of QoS data frames containing fragments may remain constant even if the amount of queued traffic changes as successive fragments are transmitted.

MAC service provides peer entities with the ability to exchange MSDUs. To support this service, a local MAC uses the underlying PHY-level service to transport the MSDUs to a peer MAC entity. Such asynchronous MSDU transport is performed on a connectionless basis.

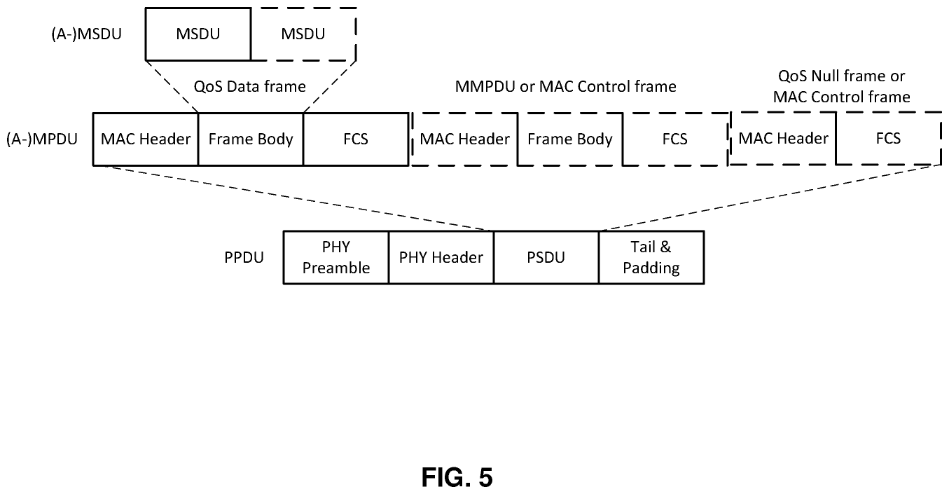

FIG. 5 illustrates an example format of a PPDU. As shown, the PPDU may include a PHY preamble, a PHY header, a PSDU, and tail and padding bits.

The PSDU may include one or more MPDUs, such as a QoS data frame, an MMPDU, a MAC control frame, or a QoS null frame. In the case of an MPDU carrying a QoS data frame, the frame body of the MPDU may include a MSDU or an A-MSDU.

By default, MSDU transport is on a best-effort basis. That is, there is no guarantee that a transmitted MSDU will be delivered successfully. However, the QoS facility uses a traffic identifier (TID) to specify differentiated services on a per-MSDU basis.

A STA may differentiate MSDU delivery according to designated traffic category (TC) or traffic stream (TS) of individual MSDUs. The MAC sublayer entities determine a user priority (UP) for an MSDU based on a TID value provided with the MSDU. The QoS facility supports eight UP values. The UP values range from 0 to 7 and form an ordered sequence of priorities, with 1 being the lowest value, 7 the highest value, and 0 falling between 2 and 3.

An MSDU with a particular UP is said to belong to a traffic category with that UP. The UP may be provided with each MSDU at the medium access control service access point (MAC SAP) directly in a UP parameter. An A-MPDU may include MPDUs with different TID values.

A STA may deliver buffer status reports (BSRs) to assist an AP in allocating UL MU resources. The STA may either implicitly deliver BSRs in the QoS control field or BSR control subfield of any frame transmitted to the AP (unsolicited BSR) or explicitly deliver BSRs in a frame sent to the AP in response to a BSRP Trigger frame (solicited BSR).

The buffer status reported in the QoS control field includes a queue size value for a given TID. The buffer status reported in the BSR control field includes an ACI bitmap, delta TID, a high priority AC, and two queue sizes.

A STA may report buffer status to the AP, in the QoS control field, of transmitted QoS null frames and QoS data frames and, in the BSR control subfield (if present), of transmitted QoS null frames, QoS data frames, and management frames as defined below.

The STA may report the queue size for a given TID in the queue size subfield of the QoS control field of transmitted QoS data frames or QoS null frames; the STA may set the queue size subfield to 255 to indicate an unknown/unspecified queue size for that TID. The STA may aggregate multiple QoS data frames or QoS null frames in an A-MPDU to report the queue size for different TIDs.

The STA may report buffer status in the BSR control subfield of transmitted frames if the AP has indicated its support for receiving the BSR control subfield.

A High-Efficiency (HE) STA may report the queue size for a preferred AC, indicated by the ACI high subfield, in the queue size high subfield of the BSR control subfield. The STA may set the queue size high subfield to 255 to indicate an unknown/unspecified queue size for that AC.

A HE STA may report the queue size for ACs indicated by the ACI bitmap subfield in the queue size all subfield of the BSR control subfield. The STA may set the queue size all subfield to 255 to indicate an unknown/unspecified BSR for those ACs.

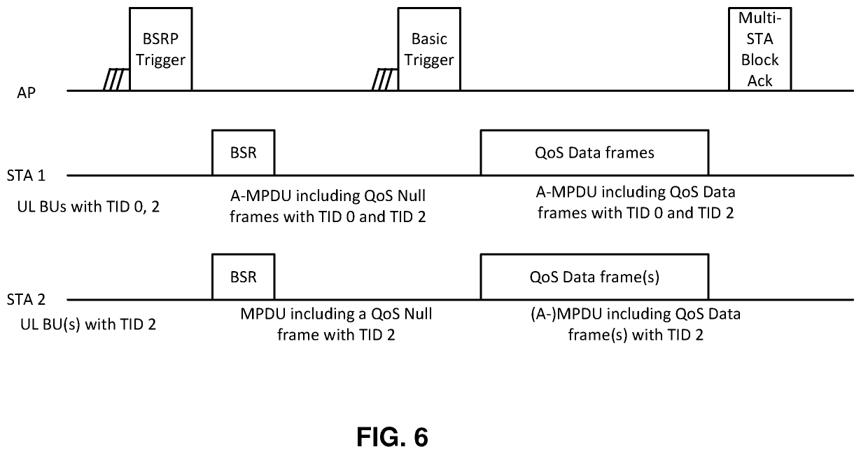

FIG. 6 illustrates an example that includes buffer status reporting by STAs, scheduling by an AP of uplink multi-user (MU) transmissions, and transmission of scheduled uplink transmissions by the STAs.

As shown, the AP may solicit one or more associated STAs (STA 1 and STA 2) for buffer status by sending a buffer status report poll (BSRP) trigger frame. Upon receiving the BSRP trigger frame, STA 1 and/or STA 2 may each generate a trigger-based (TB) PPDU if the BSRP trigger frame contains, in a User Info field, the 12 LSBs of the STA's AID.

STA 1 and/or STA 2 may each include in the TB PPDU one or more QoS null frames. The one or more QoS null frames may contain one or more QoS control fields or one or more BSR control subfields.

As described earlier, a QoS control field may include a queue size subfield for a TID for which the STA has a queue size to report to the AP. For example, as shown in FIG. 6, STA 1 may respond to the BSRP trigger frame from the AP by transmitting an A-MPDU including multiple QoS null frames. The QoS null frames each indicates, in its respective QoS control field, a queue size for a respective TID, e.g. TID 0 and TID 2. Similarly, STA 2 may respond to the BSRP trigger frame by transmitting an MPDU including a QoS null frame, which indicates a queue size for TID 2 in its QoS control field.

A BSR control subfield may include a queue size all subfield indicating the queue size for the ACs, indicated by the ACI bitmap subfield, for which the STA has a queue size to report to the AP if the AP has indicated its support for receiving the BSR control subfield. The STA sets a delta TID, a scaling factor, an ACI high, and the queue size high subfields of the BSR Control subfield.

On receiving the BSRs from STA 1 and STA 2, the AP may transmit a basic trigger frame to allocate UL MU resources to STA 1 and STA 2. In response, STA 1 may transmit a TB PPDU containing QoS data frames with TID 0 and TID 2 and STA 2 may transmit a TB PPDU containing one or more QoS data frame(s) with TID. The AP may acknowledge the transmitted TB PPDUs from STA 1 and STA 2 by sending a multi-STA block ack frame.

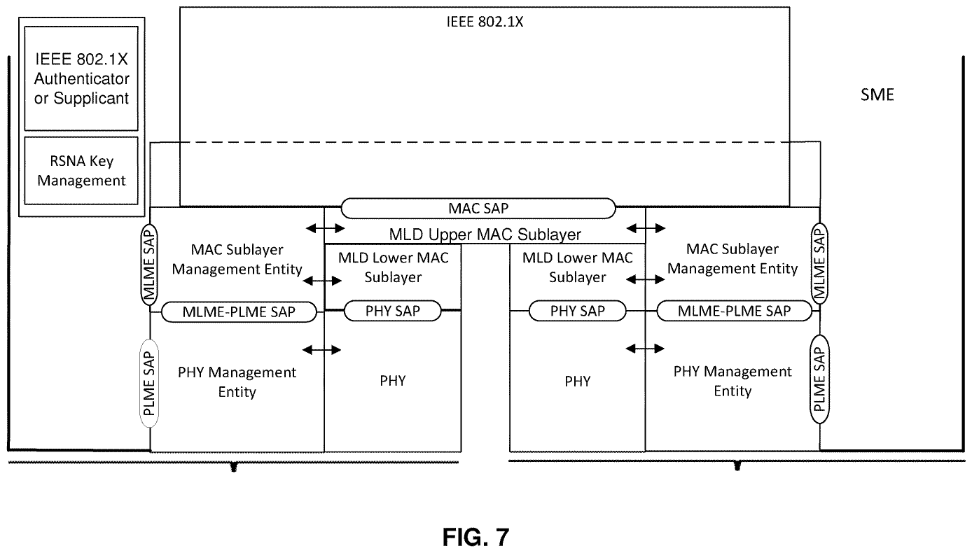

FIG. 7 illustrates an example reference model for a multi-link device (MLD).

An MLD is an entity capable of managing communication over multiple links. The MLD may be a logical entity and may have more than one affiliated station (STA). An MLD may be an access point MLD (AP MLD) where a STA affiliated with the MLD is an AP STA (or an AP). An MLD may be a non-access point MLD (non-AP MLD) where a STA affiliated with the MLD is a non-AP STA (or an STA).

Communication across different frequency bands/channels may occur simultaneously, or not, depending on the capabilities of both of the communicating AP MLD and non-AP MLD.

As shown in FIG. 7, a MLD may have a single MAC service access point (MAC-SAP) to the LLC layer, which includes a MAC data service. The MLD may support multiple MAC sublayers, coordinated by a sublayer management entity (SME). Each AP STA (or non-AP STA) affiliated with an AP MLD (or non-AP MLD) has a different MAC address within the MLD.

The SME is responsible for coordinating the MAC sublayer management entities (MLMEs) of the affiliated STAs of the MLD to maintain a single robust security network association (RSNA) key management entity as well as a single IEEE 802.1X Authenticator or Supplicant for multi-link operation (MLO).

Multi-link operation (MLO) procedures allow a pair of MLDs to discover, synchronize, (de)authenticate, (re)associate, disassociate, and manage resources with each other on any common bands or channels that are supported by both MLDs. The Authenticator and the MAC-SAP of an AP MLD may be identified by the same AP MLD MAC address. The Supplicant and the MAC-SAP of a non-AP MLD may be identified by the same non-AP MLD MAC address.

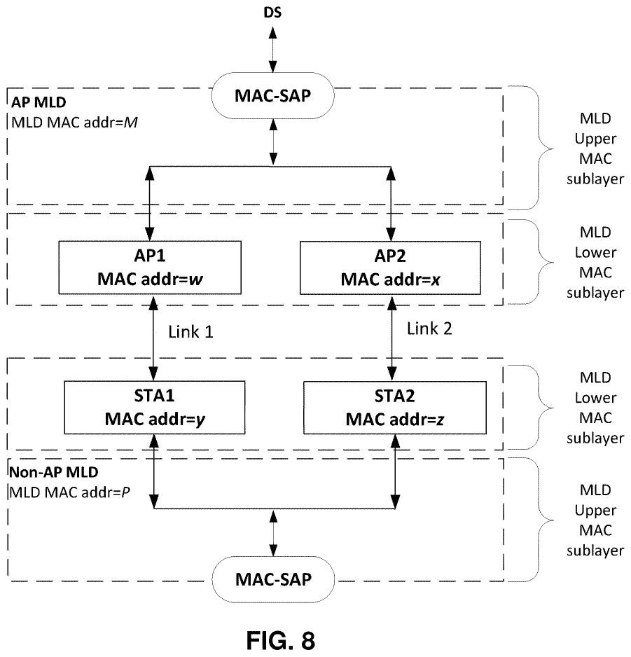

FIG. 8 illustrates an example of an AP MLD and an associated non-AP MLD.

As shown, the AP MLD has two affiliated APs (AP1 and AP2), and the non-AP MLD has two affiliated STAs (STA 1 and STA 2). The AP MLD and the non-AP MLD may be communicatively coupled by two links (Link 1 and Link 2.) Link 1 is established between AP1 and STA1, and link 2 is established between AP2 and STA2.

Generally, the MAC addresses of an MLD and of its affiliated STAs are different from one another. For example, as shown in FIG. 8, the AP MLD may have MAC address M, AP 1 may have MAC address w, and AP2 may have with MAC address x. Similarly, the non-AP MLD may have MAC address P, STA 1 may have MAC address y, and STA2 may have MAC address z.

As shown in FIG. 8, with each MLD, the MAC sublayer may be further divided into an MLD upper MAC sublayer and an MLD lower MAC sublayer. The MLD upper MAC sublayer (MLD) performs functionalities that are common across all links. The MLD lower MAC sublayer performs functionalities that are local to each link. Some of the functionalities require joint processing of both the MLD upper and the MLD lower MAC sublayers.

The MLD upper MAC sublayer functions may include:
Authentication, association, and reassociation (between an AP MLD and a non-AP MLD);
Security association (e.g., pairwise master key security association (PMKSA), pairwise transient key security association (PTKSA)) and distribution of group temporal key (GTK)/integrity GTK (IGTK)/beacon IGTK (BIGTK);
Sequence number (SN)/packet number (PN) assignment for frames to be encrypted by pairwise transient key (PTK) for unicast frames;
Encryption/decryption using PTK for unicast frames;
Selection of the MLD lower MAC sublayer for transmission (TID-to-link mapping);
Reordering of packets to ensure in-order delivery per each Block Ack session;
Block Ack scoreboarding for individually addressed frames (in collaboration with the MLD lower MAC sublayer); optionally, the MLD upper MAC sublayer delivers the Block Ack record on one link to the MLD lower MAC sublayer of other links; and
MLD level management information exchange/indication via the MLD lower MAC sublayer

The MLD lower MAC sublayer functions may include:
Maintenance of link specific GTK/IGTK/BIGTK (between an AP affiliated with the AP MLD and a STA affiliated with the non-AP MLD);
Link-specific encryption/decryption/integrity protection and PN assignment using GTK/IGTK/BIGTK (between an AP affiliated with the AP MLD and a STA affiliated with the non-AP MLD);
Link specific management information exchange/indication (e.g., beacon);
Link specific control information exchange/indication (e.g., RTS/CTS, acknowledgements, etc.);
Power save state and mode;
MAC address filtering for frame reception; and
Block Ack scoreboarding for individually addressed frames (in collaboration with the MLD upper MAC sublayer); optionally, the MLD lower MAC sublayer receives the Block Ack record on the other links from the MLD upper MAC sublayer.

Multi-link (re)setup between a non-AP MLD and an AP MLD may include an exchange of (re)association request/response frames. A (re)association request/response frame exchange for a multi-link setup may include both frames carrying a basic multi-link element.

In the (re)association request frame, the non-AP MLD indicates the links that are requested for (re)setup and the capabilities and operational parameters of the requested links. The non-AP MLD may request to (re)set up links with a subset of APs affiliated with the AP MLD. The links that are requested for (re)setup and the capabilities and operation parameters of requested links are independent of existing setup links with an associated AP MLD and the capabilities and operation parameters of setup links.

In the (re)association response frame, the AP MLD may indicate the requested links that are accepted and the requested links that are rejected for (re)setup and the capabilities and operational parameters of the requested links. The AP MLD may accept a subset of the links that are requested for (re)setup. The (re)association response frame is sent to the non-AP STA, affiliated with the non-AP MLD, that sent the (re)association request frame.

An MLD that requests or accepts multi-link (re)setup for any two links ensures that each link is located on a different nonoverlapping channel. After successful multi-link (re)setup between a non-AP MLD and an AP MLD, the non-AP MLD and the AP MLD set up links for multi-link operation, and the non-AP MLD is (re)associated with the AP MLD. For each setup link, the corresponding non-AP STA affiliated with the non-AP MLD is in the same associated state as the non-AP MLD and is associated with a corresponding AP affiliated with the AP MLD. For each setup link, functionalities between a non-AP STA and its associated AP are enabled unless the functionalities have been extended to the MLD level or specified otherwise.

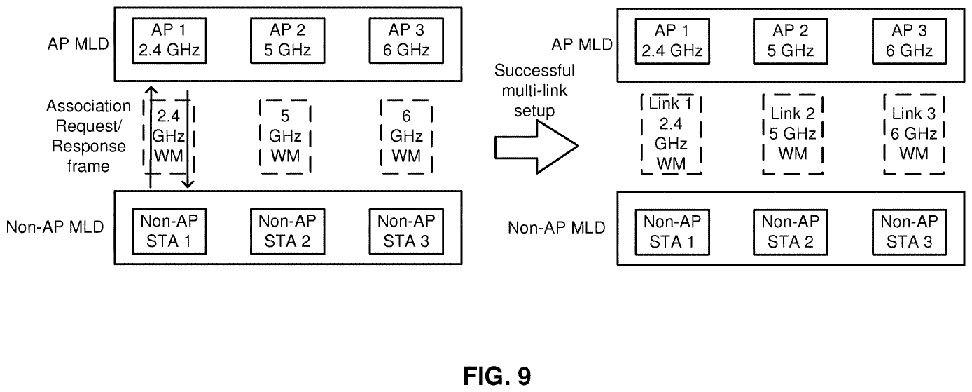

FIG. 9 illustrates an example of a multi-link setup between an AP MLD and a non-AP MLD. As shown, the AP MLD has three affiliated APs: AP 1 operating in the 2.4 GHz band, AP 2 operating in the 5 GHz band, and AP 3 operating in the 6 GHz band. The non-AP MLD has three affiliated STAs: non-AP STA 1 operating in the 2.4 GHz band, non-AP STA 2 operating in the 5 GHz band, and non-AP STA 3 operating in the 6 GHz band.

The non-AP MLD may initiate multi-link setup by non-AP STA 1 sending an association request frame to AP 1 affiliated with the AP MLD. In the association request frame, the transmitter address (TA) field is set to the MAC address of non-AP STA 1 and the receiver address (RA) field is set to the MAC address of AP 1. The association request frame includes a basic multi-link element that indicates the MLD MAC address of the non-AP MLD and complete information of non-AP STA 1, non-AP STA 2, and non-AP STA 3. The association request frame may request the setup of three links between the non-AP MLD and the AP MLD (a link between AP 1 and non-AP STA 1, a link between AP 2 and non-AP STA 2, and a link between AP 3 and non-AP STA 3).

The AP MLD may respond to the requested multi-link setup by AP sending an association response frame to non-AP STA 1 affiliated with the non-AP MLD. In the association response frame, the TA field is set to the MAC address of the AP 1 and the RA field is set to the MAC address of the non-AP STA 1. The association response frame includes a basic multi-link element that indicates the MLD MAC address of the AP MLD and complete information of AP 1, AP 2, and AP 3. The association response frame signals successful multi-link setup by the setup of three links between the non-AP MLD and AP MLD (link 1 between AP 1 and non-AP STA 1, link 2 between AP 2 and non-AP STA 2, and link 3 between AP 3 and non-AP STA 3).

By default, all TIDs at the non-AP MLD are mapped to all setup links for both uplink and downlink. The TID-to-link mapping mechanism allows an AP MLD and a non-AP MLD that performed or are performing multi-link setup to specify how UL and DL QoS traffic corresponding to different TIDs (e.g., between 0 and 7) may be assigned to the setup links. In a negotiated TID-to-link mapping, a TID may be mapped to a link set, which is a subset of setup links, ranging from a single setup link to all the setup links.

A setup link is defined as enabled for a non-AP MLD if at least one TID is mapped to that link either in DL or in UL, and is defined as disabled if no TIDs are mapped to that link both in DL and UL. At any point in time, a TID is always mapped to at least one setup link both in DL and UL, which means that a TID-to-link mapping change can only be valid and successful if it does not result in a TID having a mapped link set made of zero setup links.

By default, all setup links are enabled. If a link is enabled for a non-AP MLD, it may be used for the exchange of individually addressed frames, subject to the power state of the non-AP STA operating on that link. Only MSDUs or A-MSDUs with TIDs mapped to a link may be transmitted on that link in the direction (DL/UL) corresponding to the TID-to-link mapping. Individually addressed management frames and control frames may be sent on any enabled link between an affiliated STA of the non-AP MLD and a corresponding AP of the AP MLD, both in DL and UL.

If a link is disabled for a non-AP MLD, the link may not be used for the exchange of individually addressed frames between an affiliated STA of the non-AP MLD and a corresponding AP of the AP MLD.

If a TID is mapped in UL to a set of enabled links for a non-AP MLD, the non-AP MLD may use any link within this set of enabled links to transmit individually addressed MSDUs or A-MSDUs corresponding to that TID.

If a TID is mapped in DL to a set of enabled links for a non-AP MLD, the non-AP MLD may retrieve individually addressed BUs buffered at the AP MLD that are MSDUs or A-MSDUs corresponding to the TID, on any link of the set of enabled links. Conversely, the AP MLD may use any link within the set of enabled links to transmit individually addressed MSDUs or A-MSDUs corresponding to the TID, subject to the power state of the non-AP STA on each of the used link.

If the default mode is used, the non-AP MLD may retrieve BUs buffered by the AP MLD on any setup link, though the AP MLD may recommend a link.

A non-AP MLD may retrieve buffered BUs that are MMPDUs buffered at the AP MLD on any enabled link. An AP MLD may use any enabled link to transmit individually addressed bufferable management frames that are not measurement MMPDUs, subject to the power state of the non-AP STA on the used link. If a STA affiliated with a non-AP MLD is in active mode on a link with a set of TIDs mapped for DL transmission, its associated AP affiliated with the AP MLD may transmit to the STA: MSDUs/A-MSDUs for the set of mapped TIDs for the non-AP MLD; and MMPDUs that are not measurement MMPDUs for the non-AP MLD or its affiliated STAs, unless the frames are transmitted to another STA affiliated with the same non-AP MLD and in active mode.

As mentioned above, under the default mapping mode, all TIDs are mapped to all setup links for DL and UL, and all setup links are enabled. A non-AP MLD and an AP MLD that perform multi-link setup shall operate under this mode if a TID-to-link mapping negotiation for a different mapping has not occurred, was unsuccessful, or was torn down.

In a multi-link (re)setup procedure, a non-AP MLD may initiate a TID-to-link mapping negotiation by including a TID-to-link mapping element in a (re)association request frame if an AP MLD has indicated support for TID-to-link mapping negotiation. After receiving the (re)association request frame containing the TID-to-link mapping element, the AP MLD may reply to the (re)association request frame in according to the following rules. The AP MLD can accept the requested TID-to-link mapping indicated in the TID-to-link mapping element in the received (re)association request frame only if it accepts the multi-link (re)setup for all links on which at least one TID is requested to be mapped. In this case, the non-AP MLD does include in the (re)association response frame a TID-to-link mapping element. Otherwise, the non-AP MLD indicates rejection of the proposed TID-to-link mapping by including in the (re)association response frame a TID-to-link mapping element that suggests a preferred TID-to-link mapping.

Following a successful multi-link (re)setup, to negotiate a new TID-to-link mapping, an initiating MLD may send an individually addressed TID-to-link mapping request frame to a responding MLD that has indicated support of TID-to-link mapping negotiation.

On receiving the individually addressed TID-to-link mapping request frame, the responding MLD sends an individually addressed TID-to-link mapping response frame to the initiating MLD according to the following rules. The responding MLD may accept the requested TID-to-link mapping indicated in the TID-to-link mapping element in the received TID-to-link mapping request frame by transmitting a TID-to-link mapping response frame. Otherwise, the responding MLD may indicate rejection of the proposed TID-to-link mapping in the TID-to-link mapping response frame. The responding MLD may suggest a preferred TID-to-link mapping in the TID-to-link mapping response frame by including the TID-to-link mapping element in the TID-to-link mapping response frame.

An MLD may suggest a preferred TID-to-link mapping to a peer MLD by sending an unsolicited TID-to-link mapping response frame that includes a TID-to-link mapping element.

When a peer MLD indicates a preferred TID-to-link mapping, an MLD may take into account the preferred TID-to-link mapping when it initiates a new TID-to-link mapping. In addition, an AP MLD may take into account the traffic flow(s) affiliated with the non-AP MLD and the capabilities and constraints (if any) of the non-AP MLD.

When two MLDs have negotiated a TID-to-link mapping, either MLD may tear down the negotiated TID-to-link mapping by sending an individually addressed TID-to-link mapping teardown frame. After teardown, the MLDs operates in default mapping mode.

When an MLD successfully negotiates a TID-to-link mapping with a peer MLD, both the MLD and the peer MLD update an uplink and/or downlink TID-to-link mapping information according to the negotiated the TID-to-link mapping.

When an MLD has successfully negotiated with a peer MLD an uplink and/or downlink TID-to-link mapping in which the bit position i of a link mapping field n in the TID-to-link mapping element is set to 0, a TID n shall not be mapped to the link associated with the link ID i in uplink and/or downlink. When an MLD has successfully negotiated with a peer MLD an uplink and/or downlink TID-to-link mapping in which the bit position i of a link mapping field n in the TID-to-link mapping element is set to 1, the TID n is mapped to the link associated with the link ID i in uplink and/or downlink.

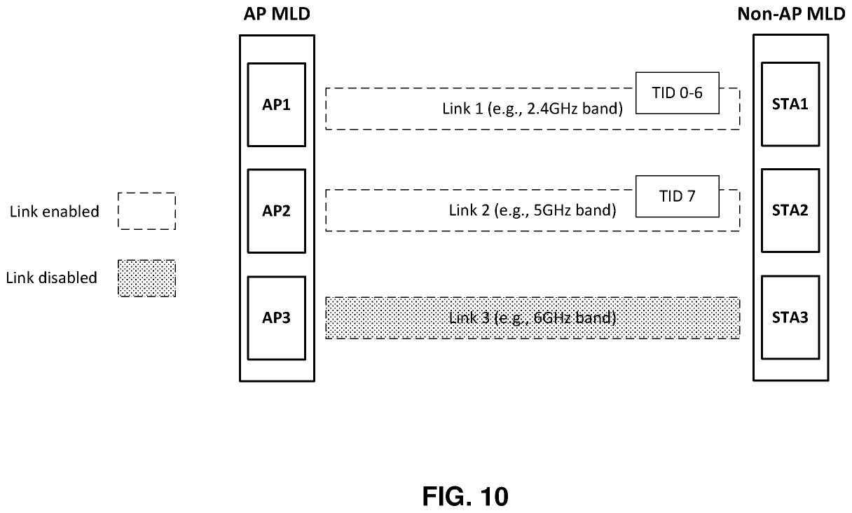

FIG. 10 illustrates an example of a TID-to-link mapping in a multi-link communication environment. As shown, the multi-link communication environment includes an AP MLD having three affiliated APs and a non-AP MLD having three affiliated STAs.

During or after multi-link setup, the non-AP MLD and the AP MLD may negotiate a TID-to-link mapping. The TID-to-link mapping maps TIDs at the non-AP MLD in UL and DL to setup links between the AP MLD and the non-AP MLD. For example, as shown in FIG. 10, the TID-to-link mapping may map TIDs 0-6 in both UL and DL to link 1 and TID 7 in both UL and DL to link 2. As such, links 1 and 2 are enabled, and link 3 is disabled. The TID-to-link mapping negotiation may be performed by exchanging an association request/response frame or a TID-to-link mapping request/response frame between the non-AP MLD and the AP MLD.

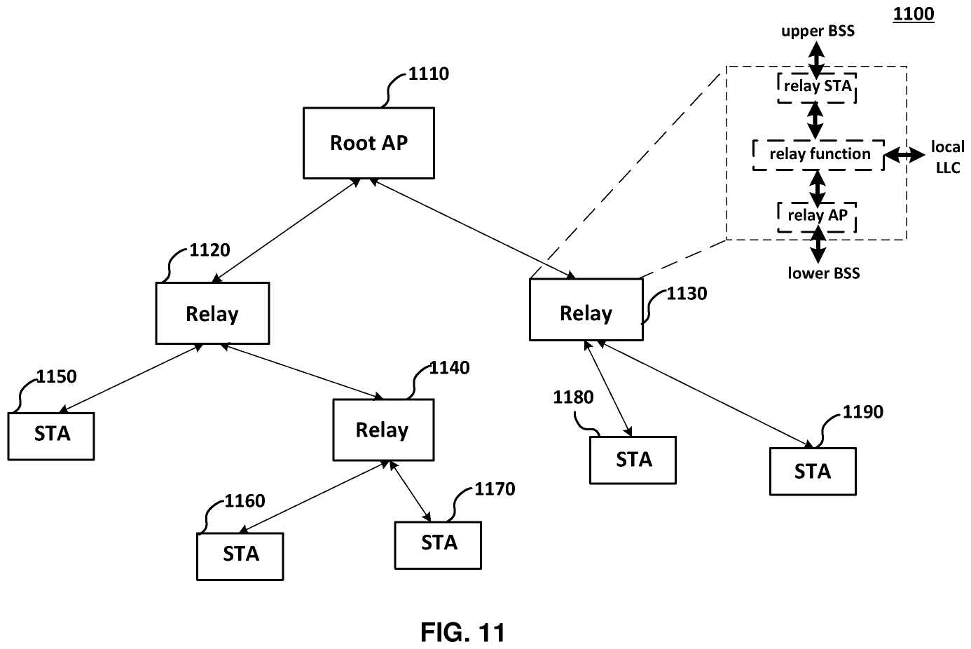

FIG. 11 illustrates an example 1100 of a sub-1 GHz (S 1G) relay architecture. Example S 1G relay architecture 1100 may be an example according to the S1G relay operation as defined in section 10.54.1 of the IEEE 802.11 standard draft “IEEE P 802.11-REVme™/D2.1, January 2023.” As shown in FIG. 11, example S1G relay architecture 1100 may include a root AP 1110, relays 1120, 1130 and 1140, and STAs 1150, 1160, 1170, 1180 and 1190.

S1G relay is a mechanism for expanding the coverage area of an AP, referred to as the root AP. In example S1G relay architecture 1100, the S1G relay mechanism is being used to expand the coverage area of root AP 1110.

As shown in FIG. 11, S1G relays 1120, 1130 and 1140 may each comprise a relay AP, a relay STA, and a relay function. The relay STA communicates with an upper BSS, whereas the relay AP communicates with a lower BSS. The relay function performs local reception or selective forwarding of MSDUs between the relay STA and the relay AP, based on destination address. In an example, relays 1120 and 1130 are associated with root AP 1110. Relay 1140 may be associated with relay 1120. In an example, STA 1150 is associated with relay 1120. STAs 1160 and 1170 may be associated with relay 1140. STAs 1180 and 1190 may be associated with relay 1130.

In an example, frames from STA 1150 are forwarded via the relay function of relay 1120 (from the relay AP to the relay STA of relay 1120) to root AP 1110. In the reverse direction, frames from root AP 1110 are forwarded to STA 1150 via the relay function of relay 1120 (from the relay STA to the relay AP of relay 1120). Similarly, STAs 1180 and 1190 may communicate with root AP 1110 via relay 1130 in both directions (e.g., uplink and downlink). On the other hand, STAs 1160 and 1170 may use relays 1140 and 1120 consecutively to communicate with root AP 1110.

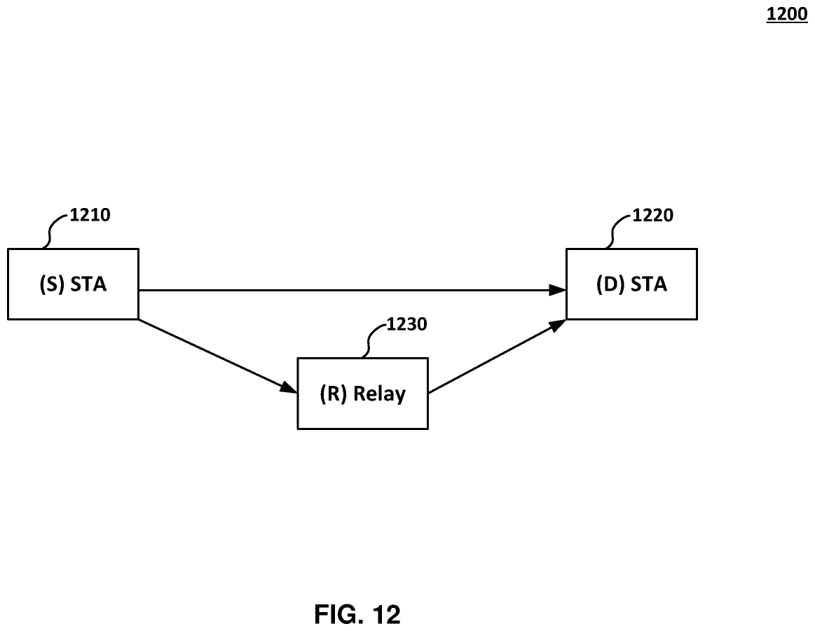

FIG. 12 illustrates an example 1200 of a source-relay-destination link. As shown in FIG. 12, source-relay-destination link 1200 may comprise a STA 1210 as a source STA, a STA 1220 as a destination STA, and a relay 1230.

STA 1210 may be a non-AP STA or an AP STA. Similarly, STA 1220 may be a non-AP STA or an AP STA. Relay 1230 may comprise a relay AP, a relay STA, and a relay function as described in FIG. 12 above. In an embodiment, STA 1210 may be an AP STA and STA 1220 may be a non-AP STA, or vice versa. In another embodiment, STAs 1210 and 1220 both may be AP STAs or non-AP STAs. STAs 1210 and 1220 may communicate directly.

Due to unreliable communication or to extend the range of existing communication, source STA 1210 may use relay 1230 to communicate with a destination STA 1220. As such, STA 1210 may transmit data frames destined to STA 1220 via relay 1230. Source STA 1210 and/or the relay 1230 may choose to protect the transmitted data frames with TXOP protection while relaying the data frames via relay 1230. In another embodiment, source STA 1210 and/or relay 1230 may choose not to protect the data frames with TXOP protection while relaying the data frames via relay 1230.

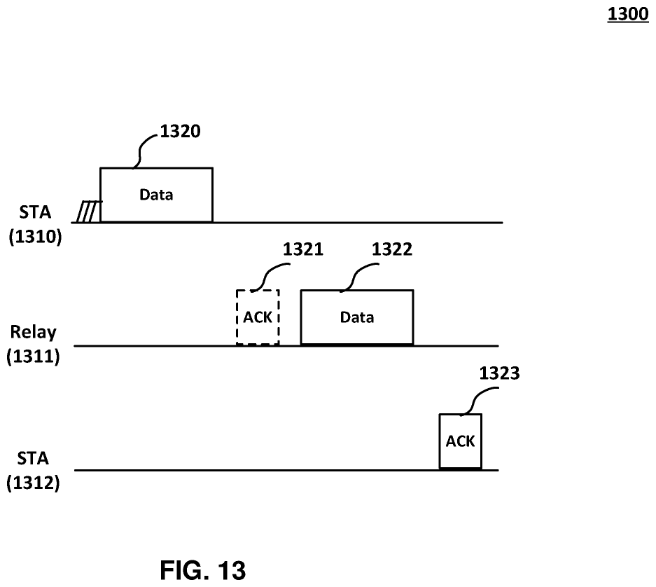

FIG. 13 is an example 1300 that illustrates relaying with no transmission opportunity (TXOP) protection. Example 1300 may be an example according to the TXOP sharing procedures for S1G relay operation as defined in section 10.54.5 of the IEEE 802.11 standard draft “IEEE P 802.11-REVme™/D2.1, January 2023.” As shown in FIG. 8, example 1300 may include STAs 1310 and 1312 and relay 1311.

In example 1300, STA 1310 may be a STA that supports TXOP sharing procedures. As shown in FIG. 13, STA 1310 may transmit a data frame 1320 destined to STA 1312 via relay 1311. Data frame 1320 may be a protocol version 1 (PV1) QoS data frame. In an implementation, STA 1310 may set a Relayed Frame field in a Frame Control field of data frame 1320 to 1. The Relayed Frame field set to 1 indicates a relay-shared TXOP. On receiving data frame 1320 with the Relay Frame field set to 1, relay 1311 may transmit an ACK frame 1321 if an explicit ACK procedure is used. Alternatively, relay 1311 may not transmit an ACK frame if an implicit ACK procedure is used.

In example 1300, relay 1311 may transmit data frame 1322 to STA 1312 without protecting data frame 1322. STA 1312 may transmit an ACK frame 1323 after receiving data frame 1322 from relay 1311. Relaying without TXOP protection may allow a lower latency transmission of data frame 1320 from STA 1310 to STA 1312. However, communication may be less reliable in case that other STAs of the same BSS may be present within the communication ranges of STAs 1310, 1312 and relay 1311. To improve communication reliability, an RTS/CTS procedure may be used to protect relayed data frames as further described below.

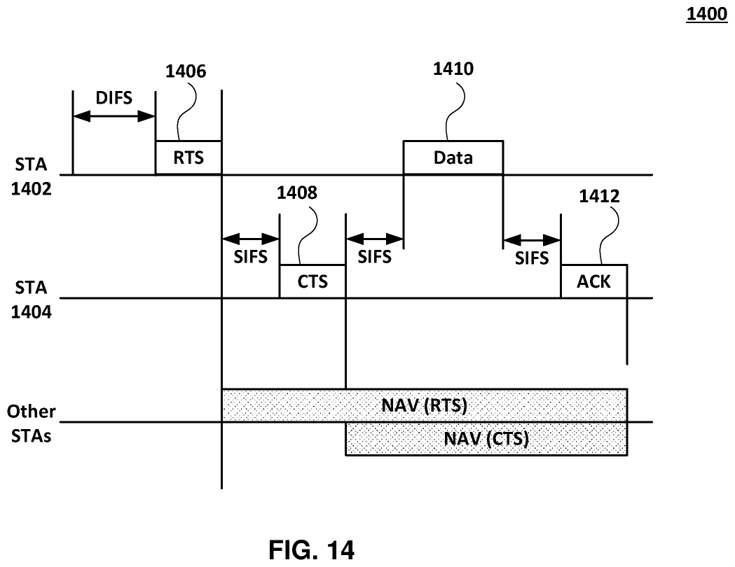

FIG. 14 illustrates an example 1400 of a Request-to-Send (RTS)/Clear-to-Send (CTS) procedure. Example RTS/CTS procedure 1400 may be an example according to the RTS/CTS procedure as defined in section 10.3.2.9 of the IEEE 802.11 standard draft “IEEE P 802.11-REVme™/D2.1, January 2023.” As shown in FIG. 14, example RTS/CTS procedure 1400 may include STAs 1402 and 1404. Other STAs of the same BSS may also be within communication range of STAs 1402 and 1404.

In an example, STA 1402 may transmit an RTS frame 1406 to STA 1404. STA 1402 may transmit RTS frame 1406 to protect from hidden STA(s) the transmission of a data frame 1410 that STA 1402 intends to transmit. RTS frame 1406 may include a Duration/ID field. The Duration/ID field may be set to the time, in microseconds, required to transmit data frame 1410, plus one CTS frame, plus one ACK frame (if required), plus three SIFS (Short Interframe Spacing) periods.

In an example, STA 1404 may respond to RTS frame 1406 by transmitting a CTS frame 1408 to STA 1402. CTS frame 1408 may be transmitted one SIFS period after RTS frame 1406. STA 1404 may respond to RTS frame 1406 when RTS frame 1406 is addressed to STA 1404 and after considering the NAV, unless the NAV was set by a frame originating from STA 1402. STA 1404 may respond to the RTS frame 1406 when RTS frame 1406 is addressed to STA 1404 and if the NAV indicates idle. For a non-S1G STA, the NAV indicates idle when the NAV count is 0 or when the NAV count is non-zero but a nonbandwidth signaling TA obtained from a TA field of RTS frame 1406 matches a saved TXOP holder address. For an S1G STA, the NAV indicates idle when both the NAV and RID (response indication deferral) counters are 0 or when either the NAV or RID counter is non-zero but the TA field of RTS frame 1406 matches the saved TXOP holder address.

STA 1404 may set an RA field of CTS frame 1408 to a nonbandwidth signaling TA obtained from the TA field of RTS frame 1406. STA 1404 may set a Duration field of CTS frame 1408 based on the Duration/ID field of RTS frame 1406, namely as equal to the value of the Duration/ID field of RTS frame 1406, adjusted by subtracting the time required to transmit CTS frame 1408 and one SIFS period.

Upon receiving CTS frame 1408, STA 1402 may wait one SIFS period before transmitting data frame 1410. STA 1404 may transmit an ACK frame 1412 in response to data frame 1410. STA 1404 may transmit ACK frame 1412 one SIFS after receiving data frame 1410.

As shown in example 1400, other STAs within communication range of STAs 1402 and 1404, and belonging to the same BSS, may set their NAVs according to RTS frame 1406 and/or CTS frame 1408. For example, a STA receiving RTS frame 1406 may set its NAV based on the Duration/ID field of RTS frame 1406. Another STA receiving CTS frame 1408 may set its NAV based on the Duration field of CTS frame 1408. As such, the other STAs may not access the channel using EDCA until the end of transmission of ACK frame 1412.

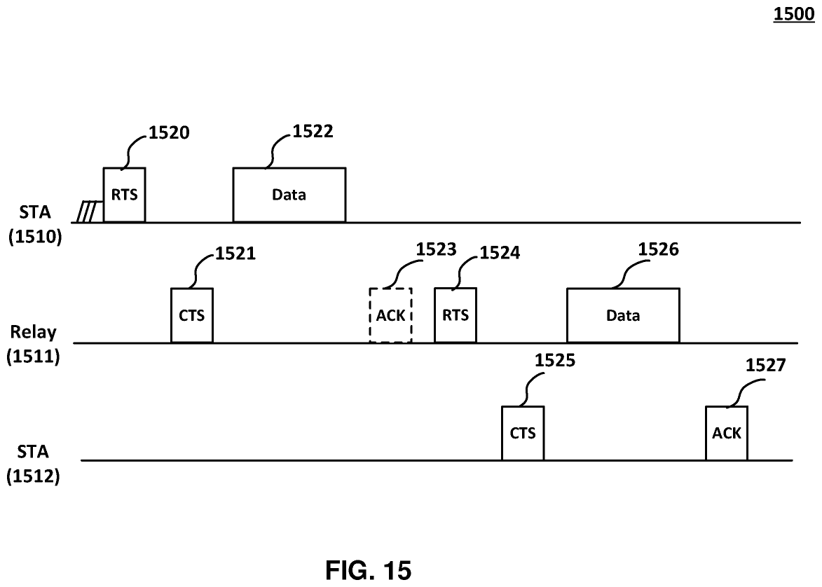

FIG. 15 is an example 1500 that illustrates relaying with TXOP protection. Example 1500 may be an example according to the TXOP sharing procedures for S1G relay operation as defined in section 10.54.5 of the IEEE 802.11 standard draft “IEEE P802.11-REVme™/D2.1, January 2023.” As shown in FIG. 15, example 1500 may include STAs 1510 and 1512 and relay 1511.

In an example, STA 1510 may be a STA that supports TXOP sharing procedures. Before transmitting a data frame 1522 to relay 1511, STA 1510 may transmit an RTS frame 1520 to relay 1511. Relay 1511 may respond to RTS frame 1520 by transmitting a CTS frame 1521 to STA 1510, if its NAV indicates idle. Upon receiving CTS frame 1521, STA 1510 may transmit data frame 1522 to relay 1511. Relay 1511 may transmit an ACK frame 1523 if an explicit ACK procedure is used. Alternatively, relay 1511 may not transmit an ACK frame if an implicit ACK procedure is used.

Similarly, before relaying receive data frame 1522 onto STA 1512, relay 1511 may transmit an RTS frame 1524 to STA 1512. STA 1512 may respond to RTS frame 1524 by transmitting a CTS frame 1525 to relay 1511, if its NAV indicates idle. Upon receiving CTS frame 1525, relay 1511 may transmit a data frame 1526 (relay of data frame 1522) to STA 1512. STA 1512 may transmit an ACK frame 1527 to relay 1511 after receiving data frame 1526.

Relaying with TXOP protection provides a more reliable approach to transmit data frames from a source STA to a destination STA. This may be achieved by using the RTS/CTS procedure sequentially in source-to-relay and relay-to-destination links. However, where the relay-to-destination link is not available due to a busy medium, there may be a delay until the relay receives a CTS frame from the destination STA and can transmit the data frame to the destination STA. An end-to-end approach that provides TXOP protection for both links may thus be more suitable to prevent any such delays.

In the next Wi-Fi standard, a triggered TXOP sharing (TXS) procedure may allow an AP to allocate a portion of the time within an obtained TXOP to a STA for transmitting one or more non-trigger-based (non-TB) PPDUs. For the triggered TXOP sharing procedure, the AP may transmit a multi-user request-to-send (MU-RTS) trigger frame with a triggered TXOP sharing mode subfield set to a non-zero value. The MU-RTS trigger frame is a trigger frame for triggering CTS frame(s) from multiple users.

In an example embodiment, an MU-RTS TXS (triggered TXOP sharing) trigger (MRTT) frame is a MU-RTS trigger frame with a triggered TXOP sharing mode subfield set to a non-zero value (e.g., 1 or 2).

In an example, during the portion of the allocated time, the STA may transmit the one or more non-TB PPDUs to the AP. In this case, a triggered TXOP sharing mode subfield in an MU-RTS TXS trigger frame may be set to 1.

In an example, during the portion of the allocated time, the STA may transmit the one or more non-TB PPDUs to the AP or a peer STA. In an example, the peer STA may be a STA with a connection for peer-to-peer (P2P) communication or direct communication with the STA. In this case, a triggered TXOP sharing mode subfield in an MU-RTS TXS trigger frame may be set to 2. In an example, the direct wireless link is established according to the tunneled direct link setup (TDLS) protocol.

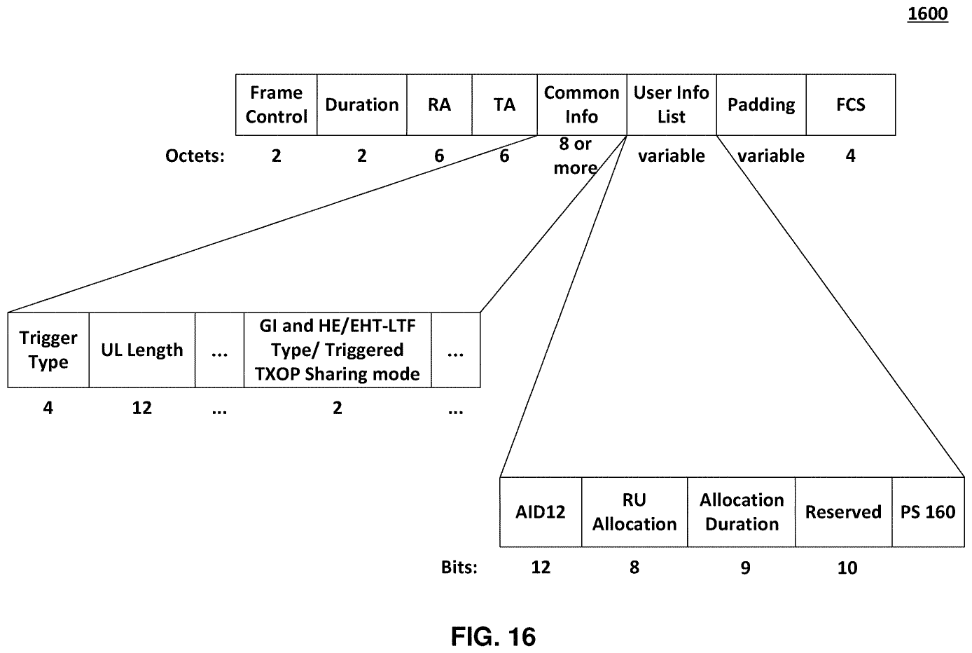

FIG. 16 is an example diagram 1600 of an MU-RTS trigger frame which may be used in a TXS procedure.

In an example, the MU-RTS trigger frame may comprise a frame control field, a duration field, a receiver address (RA) field, a transmitter address (TA) field, a common info field, a user info list field, a padding field, and/or frame check sequence (FCS) field.

In an example, the common info field may be a high-efficiency (HE) variant common info field, an extremely high throughput (EHT) variant common info field, or an ultra high reliability (UHR) variant common info field.

In an example, an EHT variant common info field may comprise one or more of the following subfields: trigger type, UL length, more TF, CS required, UL BW, GI and HE/EHT-LTF Type/Triggered TXOP sharing mode, number of HE/EHT-LTF symbols, LDPC extra symbol segment, AP Tx Power, Pre-FEC padding factor, PE disambiguity, UL spatial reuse, HE/EHT P160, special user info field flag, EHT reserved, reserved, or trigger dependent common info. The subfields of the EHT variant common info field will be presented in more detail in FIG. 16.

In an example, an EHT variant user info field may comprise one or more of the following subfields: AID12, RU allocation, allocation duration, reserved, or PS160.

In an example, the AID12 subfield of the MU-RTS trigger frame may indicate an association identifier (AID) of a STA that may use a time indicated by an allocation duration subfield of the MU-RTS trigger frame.

In an example, the RU allocation subfield of the MU-RTS trigger frame may indicate the location and size of the RU allocated for a STA indicated by an AID12 subfield, which is used together with the PS160 subfield.

In an example, the allocation duration subfield may include an allocation duration subfield (e.g., when the triggered TXOP sharing mode subfield is set to a non-zero value). The allocation duration subfield may indicate a time allocated by an AP transmitting the MU-RTS trigger frame. The allocated time may be a portion of the time of an obtained TXOP by the AP. In an example embodiment, the allocation duration subfield may indicate a first time period.

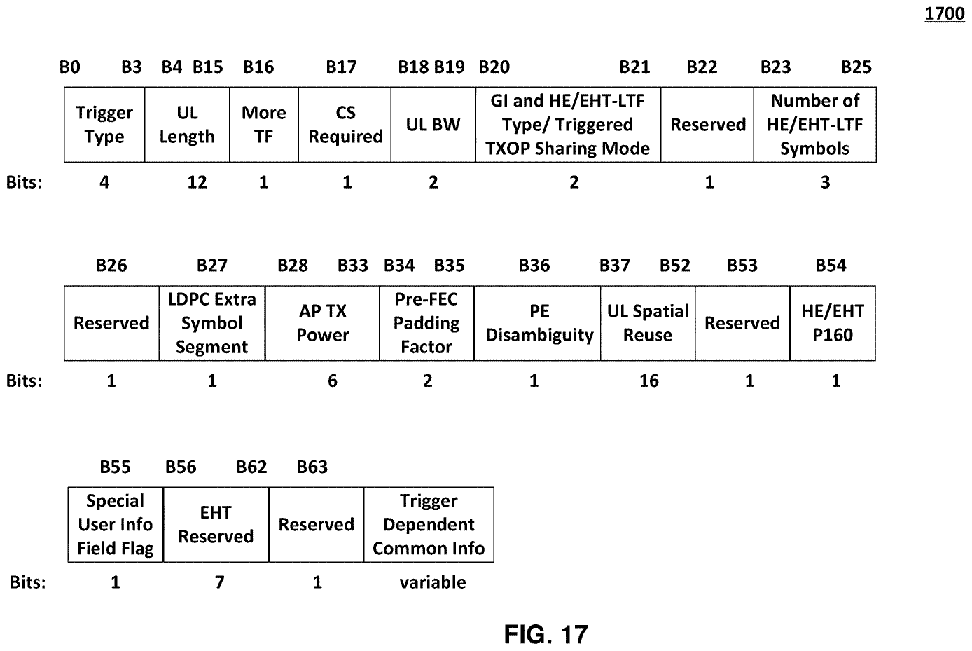

FIG. 17 illustrates an example 1700 of a common info field of an MRTT frame which may be used in a TXS procedure according to an embodiment. The MRTT frame may be transmitted by an AP to associated STAs.

In an example, an EHT variant common info field may comprise one or more of the following subfields: trigger type, UL length, more TF, CS required, UL BW, GI and HE/EHT-LTF Type/Triggered TXOP sharing mode, number of HE/EHT-LTF symbols, LDPC extra symbol segment, AP Tx Power, Pre-FEC padding factor, PE disambiguity, UL spatial reuse, HE/EHT P160, special user info field flag, EHT reserved, reserved, or trigger dependent common info.

In an example, the trigger type subfield may indicate an MU-RTS trigger frame.

In an example, the GI and HE/EHT-LTF Type/Triggered TXOP sharing mode subfield may include a triggered TXOP sharing mode subfield (e.g., when the trigger type subfield indicates an MU-RTS trigger frame).

In an example, the triggered TXOP sharing mode subfield may be set to a non-zero value (e.g., 1 or 2).

In an example, the triggered TXOP sharing mode subfield may indicate that a STA indicated by an AID12 subfield (of the user info list field) of the MU-RTS trigger frame may transmit one or more non-TB PPDUs to the AP during the time indicated by the allocation duration subfield. In this case, the triggered TXOP sharing mode subfield may be set to 1.

In an example, the triggered TXOP sharing mode subfield may indicate that a STA indicated by an AID12 subfield of the MU-RTS trigger frame may transmit one or more non-TB PPDUs to the AP or to a peer STA during the time indicated by the allocation duration subfield. In an example, the peer STA may be a STA with a connection for P2P communication or direct communication with the STA. In this case, the triggered TXOP sharing mode subfield may be set to 2.

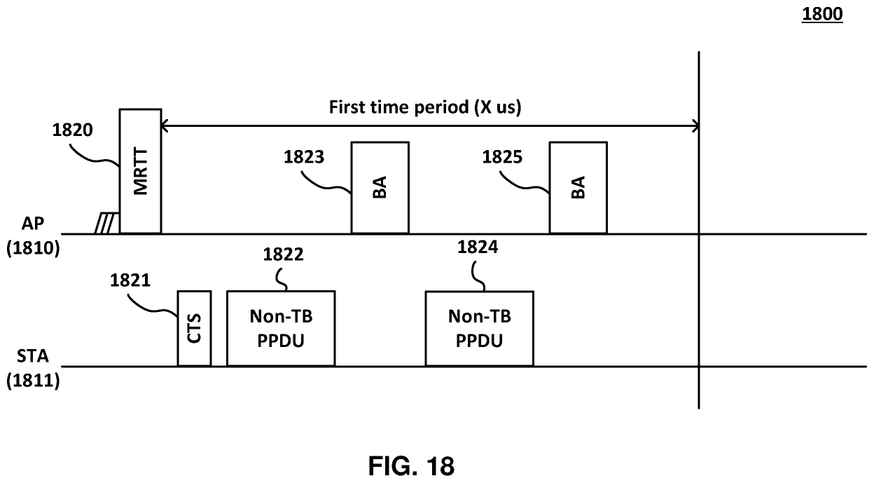

FIG. 18 illustrates an example 1800 of a TXS procedure (Mode =1). As shown in FIG. 18, the procedure may begin by an AP 1810 transmitting an MU-RTS TXS trigger (MRTT) frame 1820 to a STA 1811. MRTT frame 1820 may allocate a portion of an obtained TXOP to STA 1811 and may indicate a triggered TXOP sharing mode equal to 1. STA 1811 receiving MRTT frame 1820 may use the allocated time duration to transmit one or more non-TB PPDUs 1822, 1824 to AP 1810.

In an example, MRTT frame 1820 may comprise a triggered TXOP sharing mode subfield and/or a first time period.

In an example, the first time period may indicate a portion of a time allocated by AP 1810 within an obtained TXOP. In an example, the first time period may be indicated by a subfield in MRTT frame 1820. In an example, the first time period may be set to a value of X microseconds (us).

In an example, the triggered TXOP sharing mode subfield may be set to 1. The triggered TXOP sharing mode subfield set to 1 may indicate that STA 1811 may transmit one or more non-TB PPDUs to AP 1810 during the first time period. The one or more non-TB PPDUs may comprise a data frame, a control frame, a management frame, or an action frame.

For example, as shown in FIG. 18, MRTT frame 1820 may define a first time period of X us. STA 1811 may transmit non-TB PPDUs 1822, 1824 comprising one or more data frame to AP 1810 during the first time period, preceded by a CTS frame 1821. In an example, AP 1810 may transmit one or more Block Ack (BA) frames 1823, 1825 in response to the one or more data frames contained in non-TB PPDUs 1822, 1824 received from STA 1811.

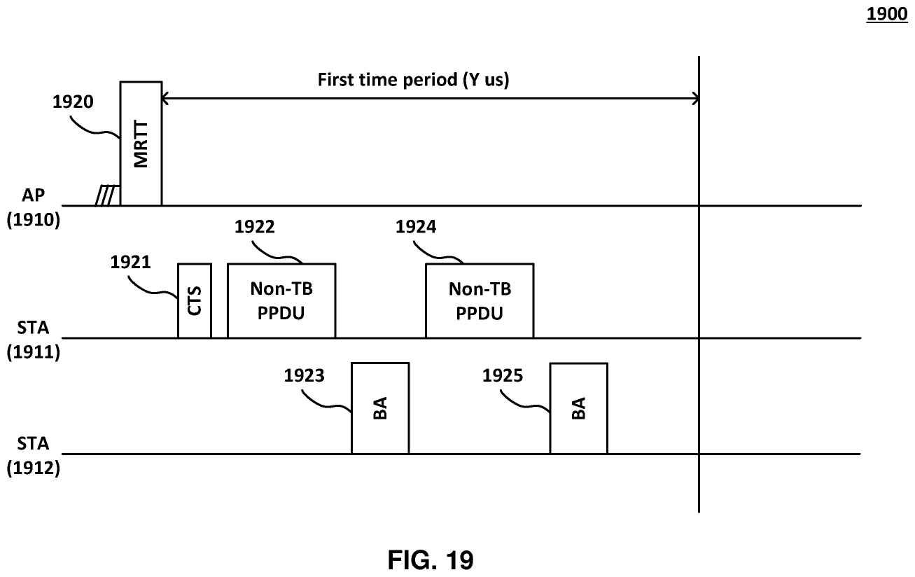

FIG. 19 illustrates an example 1900 of a TXS procedure (Mode =2). As shown in FIG. 19, the procedure may begin by an AP 1910 transmitting an MRTT frame 1920 to a STA 1911. MRTT frame 1920 may allocate a portion of an obtained TXOP to STA 1911 and may indicate a triggered TXOP sharing mode equal to 2. STA 1911 receiving MRTT frame 1920 may use the allocated time duration to transmit one or more non-TB PPDUs 1922, 1924 to STA 1912.

In an example, MRTT frame 1920 may comprise a triggered TXOP sharing mode subfield and/or a first time period.

In an example, the first time period may indicate a portion of a time allocated by AP 1910 within an obtained TXOP. In an example, the first time period may be indicated by a subfield in MRTT frame 1920. In an example, the first time period may be set to a value of Y us.

In an example, the triggered TXOP sharing mode subfield may be set to 2. The triggered TXOP sharing mode subfield set to 2 may indicate that STA 1911 may transmit one or more non-TB PPDUs to AP 1910 or to a peer STA during the first time period. In an example, the peer STA may be a STA with a connection for P2P communication or direct communication with STA 1911. The one or more non-TB PPDUs may comprise a data frame, a control frame, a management frame, or an action frame.

For example, as shown in FIG. 19, MRTT frame 1920 may define a first time period of Y us. STA 1911 may transmit non-TB PPDUs 1922, 1924 comprising one or more data frame to STA 1912 during the first time period, preceded by a CTS frame 1921. In an example, STA 1912 may transmit one or more Block Ack (BA) frames 1923, 1925 in response to the one or more data frames contained in non-TB PPDUs 1922, 1924 received from the STA 1911.

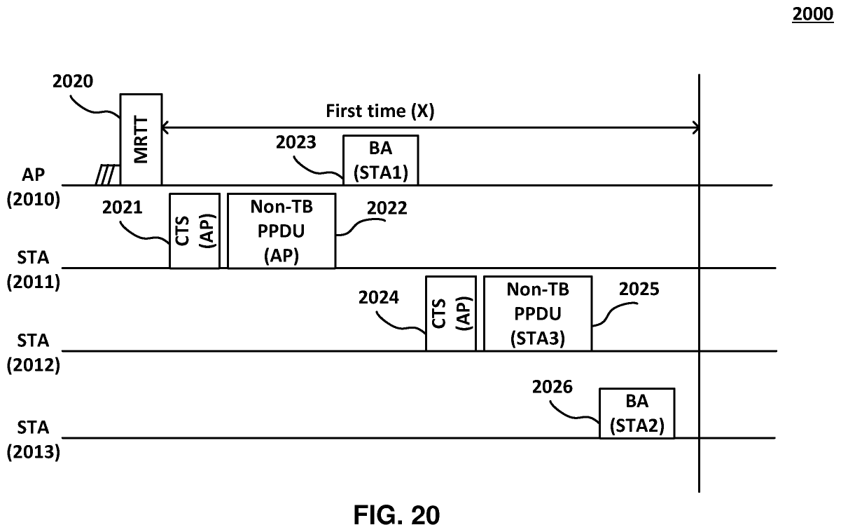

FIG. 20 illustrates an example 2000 of a TXS procedure for allocating time within an obtained TXOP to multiple STAs, with a respective triggered TXOP sharing mode indicated per STA. As shown, example 2000 may include an AP 2010 and a plurality of STAs 2011, 2012, and 2013. In an example, STAs 2011 and 2012 may be associated with AP 2010, while STA 2013 may not be associated with AP 2010.

As shown in FIG. 20, the procedure may begin by AP 2010 transmitting MRTT frame 2020. MRTT frame 2020 may allocate a time portion of an obtained TXOP to STAs 2011 and 2012 respectively. In an example, MRTT frame 2020 may indicate a respective triggered TXOP sharing mode for each of STAs 2011 and 2012.

In an example, MRTT frame 2020 may comprise a common info field.

In an example, MRTT frame 2020 may comprise a plurality of user info fields corresponding to a plurality of STAs, including STAs 2011 and 2012.

In an example, the plurality of user info fields may each include a triggered TXOP sharing mode subfield. A triggered TXOP sharing mode subfield of a user info field may indicate a TXS operation mode of a respective STA. The respective STA may be indicated by an AID12 subfield of the user info field.

In an example, a triggered TXOP sharing mode subfield of a user info field corresponding to STA 2011 may be set to 1 to indicate a Triggered TXOP sharing mode 1 for STA 2011, while a triggered TXOP sharing mode subfield of a user info field corresponding to STA 2012 may be set to 2 to indicate a Triggered TXOP sharing mode 2 for STA 2012.

In an example, the indication of a triggered TXOP sharing mode 1 for a STA in an MU-RTS TXS trigger frame may indicate that the STA may transmit a non-TB PPDU to an AP transmitting the MU-RTS TXS trigger frame, in a time allocation for the STA. The STA for which the triggered TXOP sharing mode is indicated in the MU-RTS TXS trigger frame may be indicated by an AID12 subfield of a user info field of the MU-RTS TXS trigger frame.

In an example, the indication of a triggered TXOP sharing mode 2 for a STA in an MU-RTS TXS trigger frame may indicate that the STA may transmit a non-TB PPDU to an AP transmitting the MU-RTS TXS trigger frame or to another STA, in a time allocation for the STA. The STA for which the triggered TXOP sharing mode is indicated in the MU-RTS TXS trigger frame may be indicated by an AID12 subfield of a user info field of the MU-RTS trigger frame. The other STA may be a peer STA that has a direct connection with the STA indicated by the AID12 subfield.

In example 2000, in response to MRTT frame 2020, STA 2011 may transmit a CTS frame 2021, followed by a non-TB PPDU 2022, in a respective time allocation for STA 2011. Similarly, STA 2012 may transmit a CTS frame 2024, followed by a non-TB PPDU 2025, in a respective time allocation for STA 2012.

In an example, STA 2011 may transmit non-TB PPDU 2022 to AP 2010 based on a triggered TXOP sharing mode subfield, of a user info field corresponding to STA 2011, being set to 1. In an example, STA 2011 may receive a Block Ack (BA) frame 2023, in response to non-TB PPDU 2022, from AP 2010.

In an example, STA 2012 may transmit non-TB PPDU 2025 to STA 2013 based on a triggered TXOP sharing mode subfield, of a user info field corresponding to STA 2012, being set to 2. In an example, STA 2012 may receive a Block Ack (BA) frame 2026, in response to non-TB PPDU 2025, from STA 2013.

As can be observed from example 2000, allocating a time portion of an obtained TXOP to STAs 2011 and 2012 may not be adequate to guarantee end-to-end TXOP protection for a relay operation. For example, when a TXS mode subfield of a user info field corresponding to STA 2012 is set to 2, STA 2012 may transmit a non-TB PPDU to any STA it has buffered traffic to, instead of to a predetermined relay or a destination STA.

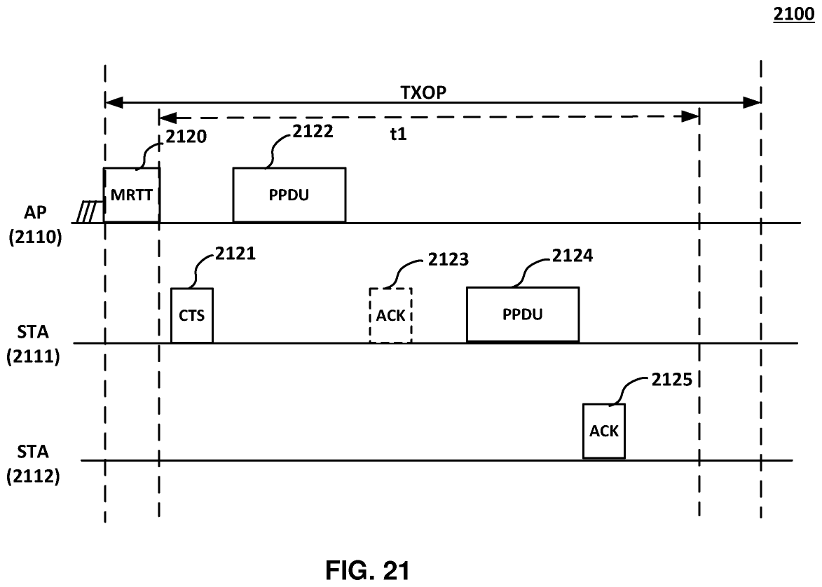

To solve this problem, TXS-based relay procedures have been proposed. FIG. 21 is an example 2100 that illustrates a TXS-based procedure, which may be used for relaying downlink traffic from an AP to a STA. As shown, example 2100 may include an AP 2110 and a plurality of STAs 2111 and 2112. In an example, STAs 2111 and 2112 may be associated with AP 2110. In an example, AP 2110 and STAs 2111 and 2112 may be within communication range of each other. In an example, STA 2111 may receive data frames from AP 2110 destined to itself. In another example, STA 2111 may serve as a relay for STA 2112. In an example, AP 2110 may prefer to transmit a PPDU to STA 2112 via STA 2111 in order to increase the throughput in a downlink transmission. In another example, AP 2110 may prefer to receive a PPDU from STA 2112 via STA 2111 in order to increase the throughput in an uplink transmission.

As shown in FIG. 21, the TXS-based relaying procedure may begin by AP 2110 transmitting an MRTT frame 2120. MRTT frame 2120 may allocate a time portion of an obtained TXOP to STA 2111. In an example, MRTT frame 2120 may indicate a triggered TXOP sharing mode for STA 2111. In an example, the triggered TXOP sharing mode may be set to 3. In an example, the triggered TXOP sharing mode being equal to 3 may indicate to STA 2111 that the allocated time portion is to be used for a relaying operation.

In an example, MRTT frame 2120 may comprise a common info field. In an example, the common info field may comprise the triggered TXOP sharing mode.

In an example, MRTT frame 2120 may comprise a user info field corresponding to STA 2111. STA 2111 may be indicated by an AID12 subfield of the user info field. In an example, the whole duration of the relaying operation may be indicated in an allocation duration field of the user info field.

In an example, the indication of a triggered TXOP sharing mode 3 for a STA in an MU-RTS TXS trigger frame may indicate that the STA may serve as a relay between the AP and another STA. In an example, after receiving the MRTT frame, where the TXS mode is 3 and STA 2111 is indicated by an AID 12 subfield of the user info field, STA 2111 may transmit a CTS frame and may receive a PPDU from the AP to be transmitted to STA 2112 in response. The address of a destination STA, e.g., STA 2112, may be indicated in the PHY header or MAC header of the PPDU. In such a case, STA 2111 acts as a relay for downlink transmission.

In example 2100, in response to MRTT frame 2120, STA 2111 may transmit a CTS frame 2121. After receiving CTS frame 2121, AP 2110 may transmit a PPDU 2122 to STA 2111. Upon receiving PPDU 2122, STA 2111 may transmit an ACK frame 2123 to AP 2110. In another embodiment, STA 2111 may not transmit an ACK frame if an implicit ACK procedure is used. STA 2111 may then transmit a PPDU 2124 to STA 2112. PPDU 2124 may be based on PPDU 2122. In an example, the data payload of PPDU 2124 may be the same as the data payload of PPDU 2122. In an example, STA 2111 may receive an ACK frame 2125 from STA 2112, in response to PPDU 2124. In an example, ACK frames 2123 and 2125 may be block ACK (BA) frames.

In one approach, as illustrated in FIG. 21, the time portion of the TXOP allocated to STA 2111 may not correspond to the end-to-end duration of the relaying operation.

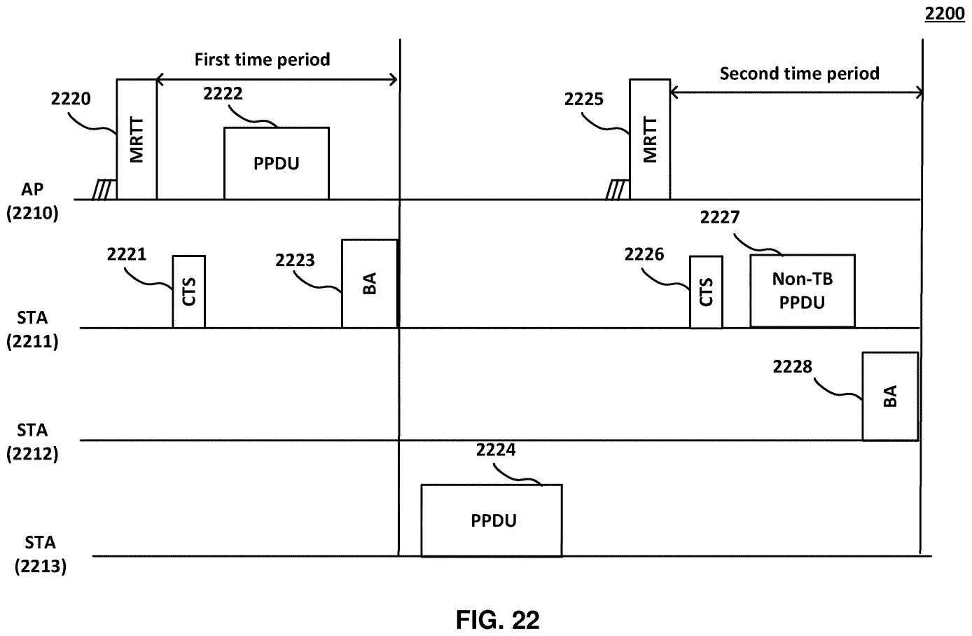

FIG. 22 is an example 2200 that illustrates a problem that may arise in the TXS-based procedure of FIG. 21. As shown, example 2200 may include an AP 2210 and a plurality of STAs 2211, 2212, and 2213. In an example, STAs 2211, 2212 and 2213 may be associated with AP 2210. STA 2212 may serve as a relay STA between the AP 2210 and the STA 2212.

As shown in FIG. 22, the TXS-based relaying procedure may begin by AP 2210 transmitting an MRTT frame 2220. MRTT frame 2220 may allocate a first time period of an obtained TXOP to STA 2211. After receiving MRTT frame 2220, STA 2211 may transmit a CTS frame 2221 and may then receive a PPDU 2222 from the AP 2210 to be transmitted to STA 2212. The address of a destination STA, e.g., STA 2212, may be indicated in the PHY header or MAC header of the PPDU 2222. After receiving PPDU 2222, STA 2211 may transmit an ACK frame 2223 to AP 2210.

In an example, as shown in FIG. 22, the first time period allocated to STA 2211 may not be long enough for STA 2211 to relay PPDU 2222 to STA 2212. One reason for such a situation may be another STA 2213 transmitting a PPDU 2224 following the first period. The PPDU 2224 may be a periodic PPDU which is expected by AP 2210. For example, PPDU 2224 may fall within a scheduled target wake time (TWT) service period (SP) for STA 2213. As such, as shown in FIG. 22, to protect the remaining hop of the relay operation, AP 2210 may transmit another MRTT frame 2225 after the transmission of PPDU 2224 has terminated. MRTT frame 2225 may allocate a second time period of an obtained TXOP to STA 2211. After receiving MRTT frame 2225, STA 2211 may transmit a CTS frame 2226 to the AP 2210 and may transmit a PPDU 2227, which includes relayed data to STA 2212 in response. STA 2212 may transmit a BA frame 2228. Such process may increase the total duration of the relaying procedure. Relay STA 2211 has to wait for the STA 2213 to finalize the transmission of PPDU 2224 and the MRTT frame 2225 from the AP 2210.

Embodiments of the present disclosure, as further described below, address the above-described problem. In one aspect, an AP may transmit a first frame comprising a first field indicating relaying, by the first STA to a second STA, of one or more frames received from the AP; and a second field indicating a second link for the relaying of the one or more frames from the first STA to the second STA.

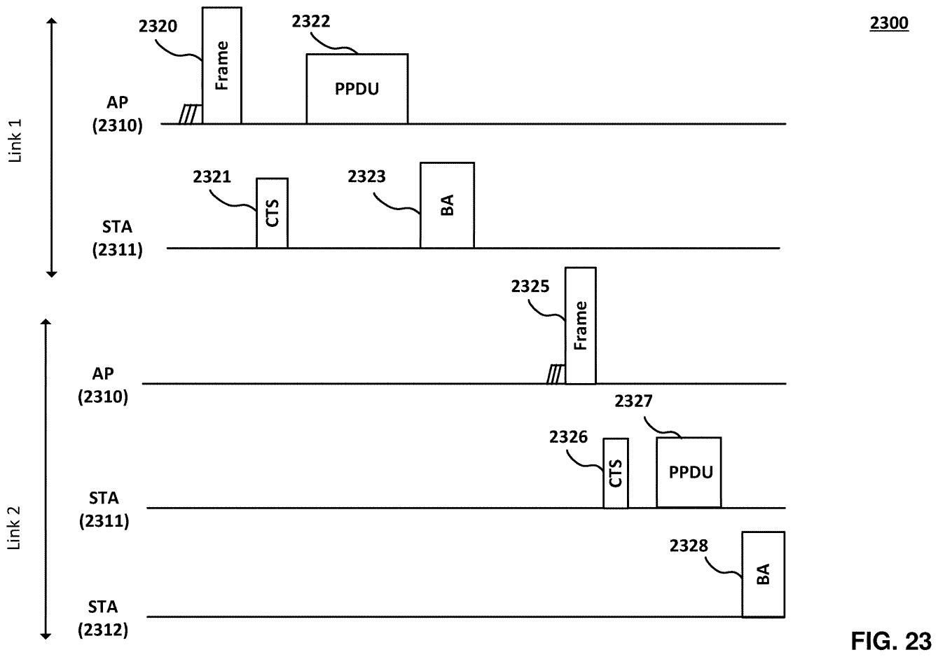

FIG. 23 illustrates an example 2300 of a multi-link relaying procedure, which may be used for relaying downlink traffic from an AP to a STA according to an embodiment. As shown in example 2300 may include an AP 2310 and plurality of STAs 2311 and 2312. In an example, STAs 2311 and 2312 may be associated with AP 2310. In an example, AP 2310, and STAs 2311 and 2312 may be within communication range of each other. In an example, STA 2311 may receive data frames from AP 2310 destined to itself. In another example, STA 2311 may serve as a relay for STA 2312. In an example, AP 2310 may prefer to transmit a PPDU to STA 2312 via STA 2311 in order to increase the throughput in a downlink transmission. In an example, as shown in FIG. 23, AP 2310 and STAs 2311 and 2312 may communicate with each other via a first link (Link 1 in FIG. 23) and a second link (Link 2 in FIG. 23). The first and second link may correspond to different frequency bands (e.g., 2.4 GHz, 5 GHz, 60 GHz, etc.)

As shown in FIG. 23, the procedure may begin with AP 2310 transmitting a frame 2320 to STA 2311 via the first link. In an embodiment, frame 2320 may comprise a first field indicating relaying, by STA 2311 to STA 2312, of one or more frames received from AP 2310. In an embodiment, frame 2320 may further comprise a second field indicating the second link for the relaying of the one or more frames from STA 2311 to STA 2312.

In an embodiment, frame 2320 may be a multi-user request-to-send (MU-RTS) frame. In an implementation, the first field may be provided in a Common Info field of the MU-RTS frame. In an example, the first field may be provided in one of the reserved bits (e.g., B22, B26, B53 or B63) of the Common Info field illustrated in FIG. 17. In an implementation, the second field may be provided in a User Info List field of the MU-RTS frame. In an implementation, the second field may be provided in one or more of the reserved bits of the User Info List field illustrated in FIG. 16.

In another embodiment, frame 2320 may be an MRTT frame. An allocation of an MRTT frame may comprise an identifier of a STA, a time period (of the TXOP) allocated to the STA, and/or a TXS mode for the allocated time period. In example 2300, where frame 2320 is an MRTT frame, frame 2320 may comprise an allocation for STA 2311. In an implementation, the first field may be provided in a TXS mode subfield of the MRTT frame. The TXS mode subfield may be provided in a Common Info field of the MRTT frame. In an embodiment, the TXS mode subfield may be set to 3 to indicate relaying. In an implementation, the first field may be provided in one of the reserved bits (e.g., B22, B26, B53 or B63) of the Common Info field illustrated in FIG. 17. In an implementation, the second field may be provided in a User Info List field of the MRTT frame. In an implementation, the second field may be provided in one or more of the reserved bits of the User Info List field illustrated in FIG. 16.

In example 2300, on receiving frame 2320, STA 2311 may determine that it is being triggered by frame 2320 to transmit a downlink frame to STA 2312 in the second link.

In an implementation, in response to frame 2320, STA 2311 may transmit a CTS frame 2321 to AP 2310. AP 2310 may then proceed to transmit a PPDU 2322 to STA 2311. PPDU 2322 may comprise one or more frames. In response to PPDU 2322, STA 2311 may transmit a BA frame 2323 to AP 2310. In another embodiment, STA 2311 may not transmit a BA frame if an implicit ACK procedure is used.

In an implementation, after receiving BA frame 2323, AP 2310 may transmit to STA 2311 a frame 2325 via the second link. In an embodiment, frame 2325 may allocate to STA 2311 a time period for transmitting the one or more frames (contained in PPDU 2322) to STA 2312 via the second link. In an implementation, frame 2325 may be an MRTT frame. In another embodiment, frame 2325 may be an MU-RTS frame.

STA 2311 may transmit a CTS frame 2326 in response to frame 2325 before transmitting a PPDU 2327 to STA 2312. PPDU 2327 may comprise the one or more frames (contained in PPDU 2322) received from AP 2310 via the first link. In another example, STA 2311 may not transmit a CTS frame before transmitting PPDU 2327 to STA 2312. STA 2312 may transmit a BA frame 2328 to STA 2311. In another embodiment, STA 2312 may not transmit a BA frame if an implicit ACK procedure is used.

In an embodiment, PPDU 2327 may be based on PPDU 2322. In an example, the data payload of PPDU 2327 may be the same as the data payload of PPDU 2322.

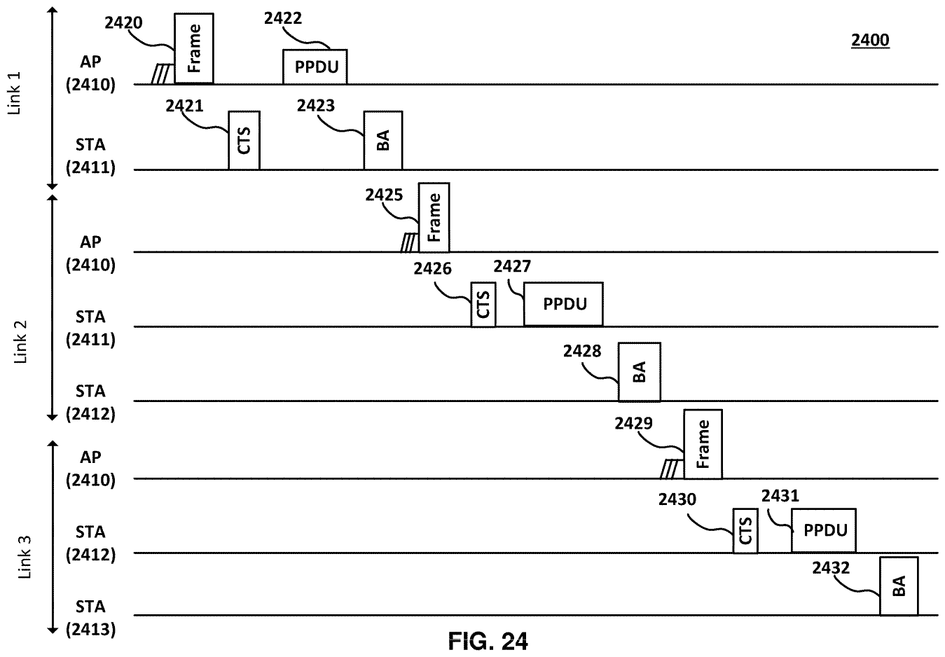

As illustrated in example 2300, the multilink relaying procedure of FIG. 23 eliminates the need for STA 2311 to wait for the first link to return to an idle state before transmitting the one or more frames to STA 2312. This is achieved by allocating a time period on the second link to STA 2311. Further, as described below with reference to FIG. 24, the multi-link relaying procedure of FIG. 24 may be readily extended to relaying operations with greater than two hops.

FIG. 24 illustrates another example 2400 of a multilink downlink relaying procedure, which may be used for relaying downlink traffic from an AP to a STA according to an embodiment. As shown, example 2400 may include an AP 2410 and a plurality of STAs 2411, 2412 and 2413. In an example, STAs 2411, 2412 and 2413 may be associated with AP 2410. In an example, AP 2410, and STAs 2411, 2412 and 2413 may be within communication range of each other. In an example, STAs 2411, 2412 and 2413 may receive data frames from AP 2410 destined to themselves. In another example, STAs 2411 and 2412 may serve as relays for STA 2413. In an example, AP 2410 may prefer to transmit a PPDU to STA 2413 via STAs 2411 and 2412 in order to increase the throughput in a downlink transmission. In an example, as shown in FIG. 24, AP 2410 and STAs 2411 and 2412 and 2413 may communicate with each other via a first link (Link 1 in FIG. 24), a second link (Link 2 in FIG. 24), a third link (Link 3 in FIG. 24). The first, second and third link may correspond to different frequency bands (e.g., 2.4 GHz, 5 GHz, 60 GHz, etc.)

As shown in FIG. 24, the procedure may begin with AP 2410 transmitting a frame 2420 to STA 2411 via the first link. In an embodiment, frame 2420 may comprise a first field indicating relaying, by STAs 2411 and 2412 to STA 2413, of one or more frames received from AP 2410. In an embodiment, frame 2420 may further comprise a second field indicating the second link for the relaying of the one or more frames from STA 2411 to STA 2412. In an embodiment, frame 2420 may further comprise a third field indicating the third link for the relaying of the one or more frames from STA 2412 to STA 2413.

In an embodiment, frame 2420 may be a multi-user request-to-send (MU-RTS) frame. In an implementation, the first field may be provided in a Common Info field of the MU-RTS frame. In an example, the first field may be provided in one of the reserved bits (e.g., B22, B26, B53 or B63) of the Common Info field illustrated in FIG. 17. In an implementation, the second field may be provided in a User Info List field of the MU-RTS frame. In an implementation, the second field may be provided in one or more of the reserved bits of the User Info List field illustrated in FIG. 16. In an implementation, the third field may be provided in one or more of the reserved bits of the User Info List field illustrated in FIG. 16.

In another embodiment, frame 2420 may be an MRTT frame. An allocation of an MRTT frame may comprise an identifier of a STA, a time period (of the TXOP) allocated to the STA, and/or a TXS mode for the allocated time period. In example 2400, where frame 2420 is an MRTT frame, frame 2420 may comprise an allocation for STA 2411. In an implementation, the first field may be provided in a TXS mode subfield of the MRTT frame. The TXS mode subfield may be provided in a Common Info field of the MRTT frame. In an embodiment, the TXS mode subfield may be set to 3 to indicate relaying. In an implementation, the first field may be provided in one of the reserved bits (e.g., B22, B26, B53 or B63) of the Common Info field illustrated in FIG. 17. In an implementation, the second field may be provided in a User Info List field of the MRTT frame. In an implementation, the second field may be provided in one or more of the reserved bits of the User Info List field illustrated in FIG. 16. The third link information can be provided in the User Info List field as illustrated in FIG. 16. In an embodiment, the MRRT frame may be indicate in an allocation duration subfield of the first user info field, an allocation duration.

In example 2400, on receiving frame 2420, STA 2411 may determine that it is being triggered by frame 2420 to transmit a downlink frame to STA 2412 in the second link.

In an implementation, in response to frame 2420, STA 2411 may transmit a CTS frame 2421 to AP 2410. AP 2410 may then proceed to transmit a PPDU 2422 to STA 2411. PPDU 2422 may comprise one or more frames. In response to PPDU 2422, STA 2411 may transmit a BA frame 2423 to AP 2410. In another embodiment, STA 2411 may not transmit a BA frame if an implicit ACK procedure is used.

In an implementation, after receiving BA frame 2423, AP 2410 may transmit to STA 2411 a frame 2425 via the second link. In an embodiment, frame 2425 may allocate to STA 2411 a time period for transmitting the one or more frames (contained in PPDU 2422) to STA 2412 via the second link. In an implementation, frame 2425 may be an MRTT frame. In another embodiment, frame 2425 may be an MU-RTS frame.

STA 2411 may transmit a CTS frame 2426 in response to frame 2425 before transmitting a PPDU 2427 to STA 2412. PPDU 2427 may comprise the one or more frames (contained in PPDU 2422) received from AP 2410 via the first link. In another example, STA 2411 may not transmit a CTS frame before transmitting PPDU 2427 to STA 2412. STA 2412 may transmit a BA frame 2428 to STA 2411. In another embodiment, STA 2412 may not transmit a BA frame if an implicit ACK procedure is used.

In an embodiment, PPDU 2427 may be based on PPDU 2422. In an example, the data payload of PPDU 2427 may be the same as the data payload of PPDU 2422.

In an implementation, after receiving BA frame 2428, AP 2410 may transmit to STA 2412 a frame 2429 via the third link. In an embodiment, frame 2429 may allocate to STA 2412 a time period for transmitting the one or more frames to STA 2413 via the third link. In an implementation, frame 2429 may be an MRTT frame. In another embodiment, frame 2429 may be an MU-RTS frame.

STA 2412 may transmit a CTS frame 2430 in response to frame 2429 before transmitting a PPDU 2431 to STA 2413. PPDU 2431 may comprise the one or more frames (contained in PPDU 2422) received from STA 2411 via the second link. In another example, STA 2412 may not transmit a CTS frame before transmitting PPDU 2431 to STA 2413. STA 2413 may transmit a BA frame 2432 to STA 2412. In another embodiment, STA 2413 may not transmit a BA frame if an implicit ACK procedure is used.

In an embodiment, PPDU 2431 may be based on PPDU 2427. In an example, the data payload of PPDU 2431 may be the same as the data payload of PPDU 2427.

As illustrated in example 2400, the multilink relaying procedure of FIG. 24 allows extending relaying operations to greater than two hops.

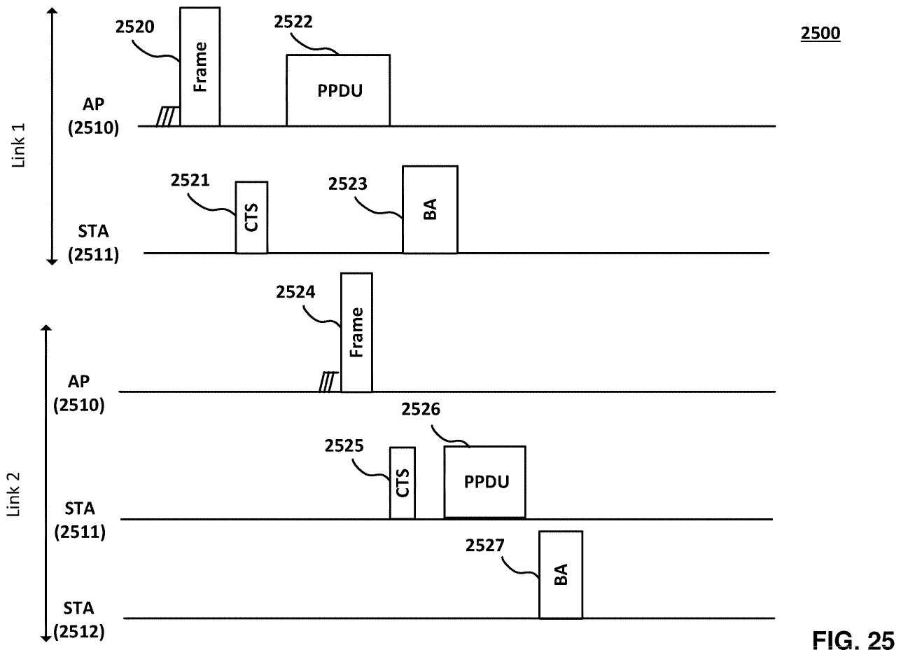

FIG. 25 illustrates an example 2500 of a multi-link relaying procedure, which may be used for relaying downlink traffic from an AP to a STA according to an embodiment. As shown in example 2500 may include an AP 2510 and plurality of STAs 2511 and 2512. In an example, STAs 2511 and 2512 may be associated with AP 2510. In an example, AP 2510, and STAs 2511 and 2512 may be within communication range of each other. In an example, STA 2511 may receive data frames from AP 2510 destined to itself. In another example, STA 2511 may serve as a relay for STA 2512. In an example, AP 2510 may prefer to transmit a PPDU to STA 2512 via STA 2511 in order to increase the throughput in a downlink transmission. In an example, as shown in FIG. 25, AP 2510 and STAs 2511 and 2512 may communicate with each other via a first link (Link 1 in FIG. 25) and a second link (Link 2 in FIG. 25). The first and second link may correspond to different frequency bands (e.g., 2.4 GHz, 5 GHz, 60 GHz, etc.)

As shown in FIG. 25, the procedure may begin with AP 2510 transmitting a frame 2520 to STA 2511 via the first link. In an embodiment, frame 2520 may comprise a first field indicating relaying, by STA 2511 to STA 2512, of one or more frames received from AP 2510. In an embodiment, frame 2520 may further comprise a second field indicating the second link for the relaying of the one or more frames from STA 2511 to STA 2512.

In an embodiment, frame 2520 may be a multi-user request-to-send (MU-RTS) frame. In an implementation, the first field may be provided in a Common Info field of the MU-RTS frame. In an example, the first field may be provided in one of the reserved bits (e.g., B22, B26, B53 or B63) of the Common Info field illustrated in FIG. 17. In an implementation, the second field may be provided in a User Info List field of the MU-RTS frame. In an implementation, the second field may be provided in one or more of the reserved bits of the User Info List field illustrated in FIG. 16.

In another embodiment, frame 2520 may be an MRTT frame. An allocation of MRTT frame 2520 may comprise an identifier of a STA, a time period (of the TXOP) allocated to the STA, and/or a TXS mode for the allocated time period. In example 2500, where frame 2520 is an MRTT frame, frame 2520 may comprise an allocation for STA 2511. In an implementation, the first field may be provided in a TXS mode subfield of the MRTT frame. The TXS mode subfield may be provided in a Common Info field of the MRTT frame. In an embodiment, the TXS mode subfield may be set to 3 to indicate relaying. In an implementation, the first field may be provided in one of the reserved bits (e.g., B22, B26, B53 or B63) of the Common Info field illustrated in FIG. 17. In an implementation, the second field may be provided in a User

Info List field of the MRTT frame. In an implementation, the second field may be provided in one or more of the reserved bits of the User Info List field illustrated in FIG. 16. In an embodiment, the MRRT frame may be indicate in an allocation duration subfield of the first user info field, an allocation duration.

In example 2500, on receiving frame 2520, STA 2511 may determine that it is being triggered by frame 2520 to transmit a downlink frame to STA 2512 in the second link.

In an implementation, in response to frame 2520, STA 2511 may transmit a CTS frame 2521 to AP 2510. AP 2510 may then proceed to transmit a PPDU 2522 to STA 2511. PPDU 2522 may comprise one or more frames. In response to PPDU 2522, STA 2511 may transmit a BA frame 2523 to AP 2510. In another embodiment, STA 2511 may not transmit a BA frame if an implicit ACK procedure is used.

In an implementation, while transmitting PPDU 2522 or without waiting for the reception of BA frame 2523, AP 2510 may begin transmission to STA 2511 of a frame 2524 via the second link. In an embodiment, frame 2524 may allocate to STA 2511 a time period for transmitting the one or more frames (contained in PPDU 2522) to STA 2512 via the second link. In an implementation, frame 2524 may be an MRTT frame. In another embodiment, frame 2524 may be an MU-RTS frame.

STA 2511 may transmit a CTS frame 2525 in response to frame 2524 before transmitting a PPDU 2526 to STA 2512. PPDU 2526 may comprise the one or more frames (contained in PPDU 2522) received from AP 2510 via the first link. In another example, STA 2511 may not transmit a CTS frame before transmitting PPDU 2526 to STA 2512. STA 2512 may transmit a BA frame 2527 to STA 2511. In another embodiment, STA 2512 may not transmit a BA frame if an implicit ACK procedure is used.

In an embodiment, PPDU 2526 may be based on PPDU 2522. In an example, the data payload of PPDU 2526 may be the same as the data payload of PPDU 2522.

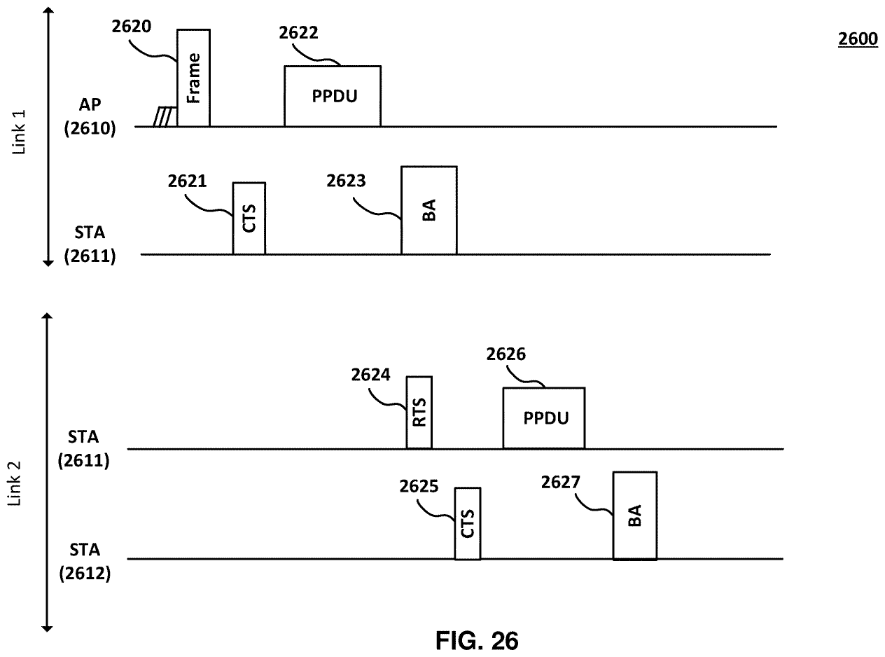

FIG. 26 illustrates an example 2600 of a multi-link relaying procedure, which may be used for relaying downlink traffic from an AP to a STA according to an embodiment. As shown in example 2600 may include an AP 2610 and plurality of STAs 2611 and 2612. In an example, STAs 2611 and 2612 may be associated with AP 2610. In an example, AP 2610, and STAs 2611 and 2612 may be within communication range of each other. In an example, STA 2611 may receive data frames from AP 2610 destined to itself. In another example, STA 2611 may serve as a relay for STA 2612. In an example, AP 2610 may prefer to transmit a PPDU to STA 2612 via STA 2611 in order to increase the throughput in a downlink transmission. In an example, as shown in FIG. 26, AP 2610 and STAs 2611 and 2612 may communicate with each other via a first link (Link 1 in FIG. 26) and a second link (Link 2 in FIG. 26). The first and second link may correspond to different frequency bands (e.g., 2.4 GHz, 5 GHz, 60 GHz, etc.)

As shown in FIG. 26, the procedure may begin with AP 2610 transmitting a frame 2620 to STA 2611 via the first link. In an embodiment, frame 2620 may comprise a first field indicating relaying, by STA 2611 to STA 2612, of one or more frames received from AP 2610. In an embodiment, frame 2620 may further comprise a second field indicating the second link for the relaying of the one or more frames from STA 2611 to STA 2612.

In an embodiment, frame 2620 may be a multi-user request-to-send (MU-RTS) frame. In an implementation, the first field may be provided in a Common Info field of the MU-RTS frame. In an example, the first field may be provided in one of the reserved bits (e.g., B22, B26, B53 or B63) of the Common Info field illustrated in FIG. 17. In an implementation, the second field may be provided in a User Info List field of the MU-RTS frame. In an implementation, the second field may be provided in one or more of the reserved bits of the User Info List field illustrated in FIG. 16.

In another embodiment, frame 2620 may be an MRTT frame. An allocation of MRTT frame 2620 may comprise an identifier of a STA, a time period (of the TXOP) allocated to the STA, and/or a TXS mode for the allocated time period. In example 2600, where frame 2620 is an MRTT frame, frame 2620 may comprise an allocation for STA 2611. In an implementation, the first field may be provided in a TXS mode subfield of the MRTT frame. The TXS mode subfield may be provided in a Common Info field of the MRTT frame. In an embodiment, the TXS mode subfield may be set to 3 to indicate relaying. In an implementation, the first field may be provided in one of the reserved bits (e.g., B22, B26, B53 or B63) of the Common Info field illustrated in FIG. 17. In an implementation, the second field may be provided in a User Info List field of the MRTT frame. In an implementation, the second field may be provided in one or more of the reserved bits of the User Info List field illustrated in FIG. 16.

In example 2600, on receiving frame 2620, STA 2611 may determine that it is being triggered by frame 2620 to transmit a downlink frame to STA 2612 in the second link.

In an implementation, in response to frame 2620, STA 2611 may transmit a CTS frame 2621 to AP 2610. AP 2610 may then proceed to transmit a PPDU 2622 to STA 2611. PPDU 2322 may comprise one or more frames. In response to PPDU 2622, STA 2611 may transmit a BA frame 2623 to AP 2610. In another embodiment, STA 2611 may not transmit a BA frame if an implicit ACK procedure is used.

In an implementation, after receiving PPDU 2622, STA 2611 may transmit an RTS frame 2624 on the second link to reserve the second link for relaying to STA 2612 the one or more frames comprised in PPDU 2622. In an embodiment, STA 2611 may transmit RTS frame 2624 as soon as it receives or while receiving PPDU 2622. In another embodiment, STA 2611 may transmit RTS frame 2624 after transmitting BA frame 2623 via the first link.

STA 2612 may transmit a CTS frame 2625 in response to RTS frame 2624 to STA 2611. After receiving CTS frame 2625, STA 2611 may transmit a PPDU 2626 to STA 2612. PPDU 2626 may comprise the one or more frames (contained in PPDU 2622) received from AP 2610 via the first link. STA 2612 may transmit a BA frame 2627 to STA 2611 in response to PPDU 2626. In another embodiment, STA 2612 may not transmit a BA frame if an implicit ACK procedure is used.

In an embodiment, PPDU 2626 may be based on PPDU 2622. In an example, the data payload of PPDU 2626 may be the same as the data payload of PPDU 2622.

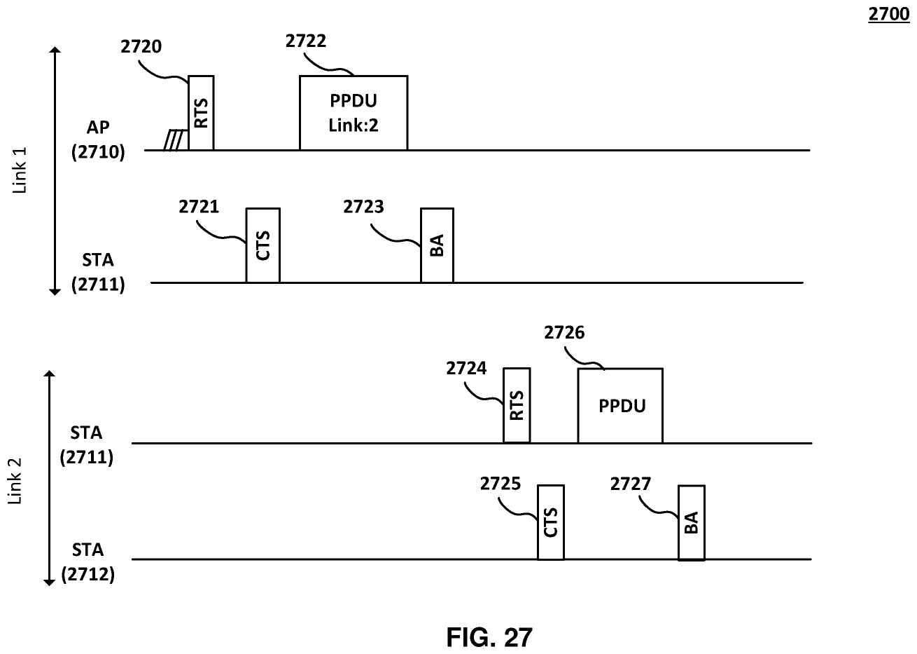

FIG. 27 illustrates an example 2700 of a multi-link relaying procedure, which may be used for relaying downlink traffic from an AP to a STA according to an embodiment. As shown in example 2700 may include an AP 2710 and plurality of STAs 2711 and 2712. In an example, STAs 2711 and 2712 may be associated with AP 2710. In an example, AP 2710, and STAs 2711 and 2712 may be within communication range of each other. In an example, STA 2711 may receive data frames from AP 2710 destined to itself. In another example, STA 2711 may serve as a relay for STA 2712. In an example, AP 2710 may prefer to transmit a PPDU to STA 2712 via STA 2711 in order to increase the throughput in a downlink transmission. In an example, as shown in FIG. 27, AP 2710 and STAs 2711 and 2712 may communicate with each other via a first link (Link 1 in FIG. 27) and a second link (Link 2 in FIG. 27). The first and second link may correspond to different frequency bands (e.g., 2.4 GHz, 5 GHz, 60 GHz, etc.)

As shown in FIG. 27, the procedure may begin with AP 2710 transmitting an RTS frame 2720 to STA 2711 via the first link to reserve the first link for the transmission of a PPDU to STA 2711. STA 2711 may transmit a CTS frame 2721 to AP 2710 in response to RTS frame 2720. After receiving CTS frame 2721, AP 2710 may transmit a PPDU 2722 to STA 2711. In an embodiment, PPDU 2722 may comprise a first field indicating multi-link relaying, by STA 2711 to STA 2712, of one or more frames comprised in PPDU 2722. In an embodiment, PPDU 2722 may further comprise a second field indicating the second link for the relaying of the one or more frames from STA 2711 to STA 2712.

In an embodiment, the first field of PPDU 2722 may comprise a portion of a physical layer (PHY) header or a portion of a medium access control (MAC) header comprised in PPDU 2722. In an embodiment, the second field may comprise a portion of a physical layer (PHY) header and a portion of a medium access control (MAC) header comprised in PPDU 2722.

In an embodiment, as described above in FIG. 27, the PPDU 2722 may comprise a PHY header comprising a receiver address (RA) and a destination address (DA) of the PPDU. In an embodiment, as described above in FIG. 27, the PPDU 2722 may comprise a PHY header comprising a flag indicating multi-link relaying and an RA of the PPDU. In an embodiment, as described above in FIG. 27, the PPDU 2722 may comprise a PHY header comprising a flag for multi-link relaying. In an embodiment, the PHY header may be a PHY header of an Extremely High Throughput (EHT) multi-user (MU) PPDU. EHT MU PPDU may comprise a PHY header, where PHY header may comprise non-high throughput (non-HT) signal field (L-SIG), repeated L-SIG (RL-SIG), universal signal field (U-SIG) and EHT signal field (EHT-SIG). EHT-SIG may further comprise a common field and a user specific field. User specific field may comprise multiple user fields to include RA and DA. In addition, indication for multi-link relaying may be signaled in the user specific field, if it is used in the procedure. User specific field may comprise the second field indicating the second link for the relaying.

In an embodiment, as described above in FIG. 27, the PPDU from the source AP (PPDU 2722) may comprise a MAC header comprising a receiver address (RA) and a destination address (DA) of a data unit of the PPDU 2722. In an embodiment, as described above in FIG. 27, the indication for multi-link relaying (e.g., first field) may be signaled in an HT control field of the MAC header. HT Control field may comprise the second field indicating the second link for the relaying.

In example 2700, on receiving PPDU 2722, STA 2711 may determine that it is to relay one or more frames comprised in PPDU 2722 to STA 2712 via the second link.

In response to PPDU 2722, STA 2711 may transmit a BA frame 2723 to AP 2710. In another embodiment, STA 2711 may not transmit a BA frame if an implicit ACK procedure is used.

In an implementation, after receiving PPDU 2722, STA 2711 may transmit an RTS frame 2724 via the second link to reserve the second link for the transmission of the one or more frames to STA 2712.

STA 2712 may transmit a CTS frame 2725 in response to RTS frame 2724 to STA 2611. After receiving CTS frame 2725, STA 2711 may transmit a PPDU 2726 to STA 2712. PPDU 2726 may comprise the one or more frames (contained in PPDU 2722) received from AP 2710 via the first link. STA 2712 may transmit a BA frame 2727 to STA 2711 in response to PPDU 2726. In another embodiment, STA 2712 may not transmit a BA frame if an implicit ACK procedure is used.

In an embodiment, PPDU 2726 may be based on PPDU 2722. In an example, the data payload of PPDU 2726 may be the same as the data payload of PPDU 2722.

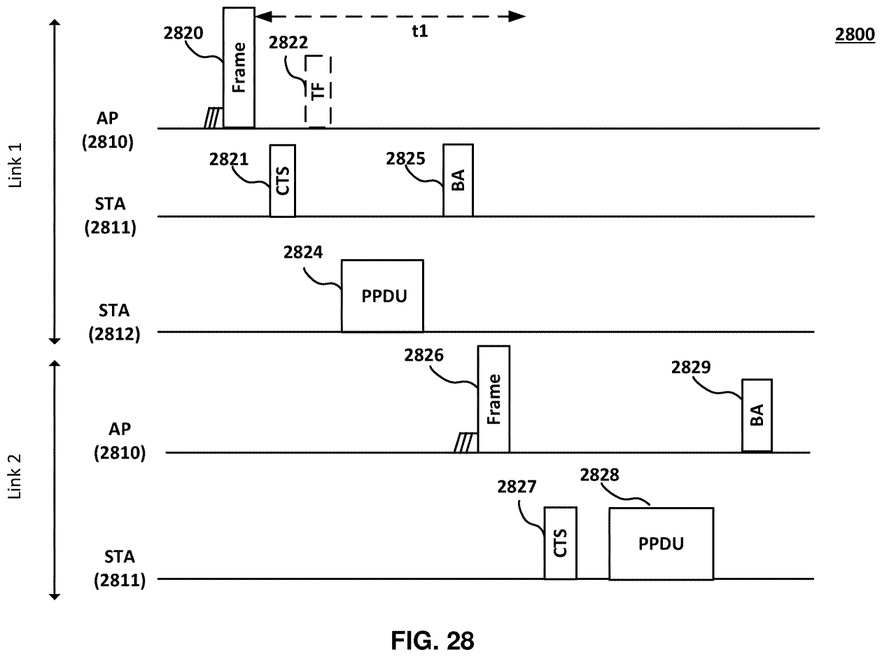

FIG. 28 illustrates an example 2800 of a multi-link relaying procedure, which may be used for relaying uplink traffic from a STA to an AP according to an embodiment. As shown in example 2800 may include an AP 2810 and plurality of STAs 2811 and 2812. In an example, STAs 2811 and 2812 may be associated with AP 2810. In an example, AP 2810, and STAs 2811 and 2812 may be within communication range of each other. In an example, AP 2810 may receive data frames from STA 2812 destined to itself. In another example, STA 2811 may serve as a relay for AP 2810. In an example, AP 2810 may prefer to transmission of a PPDU from STA 2812 via STA 2811 in order to increase the throughput in an uplink transmission. In an example, as shown in FIG. 28, AP 2810 and STAs 2811 and 2812 may communicate with each other via a first link (Link 1 in FIG. 28) and a second link (Link 2 in FIG. 28). The first and second link may correspond to different frequency bands (e.g., 2.4 GHz, 5 GHz, 60 GHz, etc.)

As shown in FIG. 28, the procedure may begin with AP 2810 transmitting a frame 2820 to STA 2811 via the first link. In an embodiment, frame 2820 may comprise a first field indicating relaying, from STA 2811 to AP 2810, of one or more frames received from STA 2812. In an embodiment, frame 2820 may further comprise a second field indicating the second link for the relaying of the one or more frames from STA 2811 to AP 2810.

In an embodiment, frame 2820 may be a multi-user request-to-send (MU-RTS) frame. In an implementation, the first field may be provided in a Common Info field of the MU-RTS frame. In an example, the first field may be provided in one of the reserved bits (e.g., B22, B26, B53 or B63) of the Common Info field illustrated in FIG. 17. In an implementation, the second field may be provided in a User Info List field of the MU-RTS frame. In an implementation, the second field may be provided in one or more of the reserved bits of the User Info List field illustrated in FIG. 16.

In another embodiment, frame 2820 may be an MRTT frame. An allocation of an MRTT frame may comprise an identifier of a STA, a time period (of the TXOP) allocated to the STA, and/or a TXS mode for the allocated time period. In example 2800, where frame 2820 is an MRTT frame, frame 2820 may comprise an allocation for STA 2811, which allocates a time period t1 to STA 2811 on the first link. In an implementation, the first field may be provided in a TXS mode subfield of the MRTT frame. The TXS mode subfield may be provided in a Common Info field of the MRTT frame. In an embodiment, the TXS mode subfield may be set to 3 to indicate relaying. In an implementation, the first field may be provided in one of the reserved bits (e.g., B22, B26, B53 or B63) of the Common Info field illustrated in FIG. 17. In an implementation, the second field may be provided in a User Info List field of the MRTT frame. In an implementation, the second field may be provided in one or more of the reserved bits of the User Info List field illustrated in FIG. 16.

In example 2800, on receiving frame 2820, STA 2811 may determine that it is to receive, during the time period (t1) allocated to STA 2811 in MRTT frame 2820, a frame via the first link for relaying to AP 2810 via the second link. Frame 2820 may or may not comprise information regarding that the frame to be received via the first link will be received from STA 2812.

In an implementation, in response to frame 2820, STA 2811 may transmit a CTS frame 2821 to AP 2810. On receiving CTS frame 2821, AP 2810 may proceed to transmit a trigger frame (TF) 2822 to STA 2812. Upon receiving frame 2822, STA 2812 may determine that it is being triggered by frame 2822 to transmit a PPDU 2824 to STA 2811 via the first link. PPDU 2824 may comprise one or more frames. In response to PPDU 2824, STA 2811 may transmit a BA frame 2825 to STA 2812. In another embodiment, STA 2812 may not transmit a BA frame if an implicit ACK procedure is used.

In an implementation, on hearing BA frame 2825, AP 2810 may transmit to STA 2811 a frame 2826 via the second link. For example, frame 2826 may be transmitted a SIFS after AP 2810 receives BA frame 2825. In another implementation, AP 2810 may transmit frame 2826 a fixed period after transmission of frame 2822.

In an embodiment, frame 2826 may allocate to STA 2811 a time period for transmitting the one or more frames (contained in PPDU 2824) to AP 2810 via the second link. In an embodiment, the time period allocated to STA 2811 may be within a TXOP obtained by AP 2810 on the second link. In an implementation, frame 2826 may be an MRTT frame.

In another embodiment, frame 2826 may be an MU-RTS frame. The MU-RTS frame may indicate a duration for transmission of the one or more frames from STA 2811 to AP 2810 via the second link.

In an implementation, STA 2811 may transmit a CTS frame 2827 in response to frame 2826, before transmitting a PPDU 2828 to AP 2810. PPDU 2828 may comprise the one or more frames (contained in PPDU 2824) received from STA 2812 via the first link. In another example, STA 2811 may not transmit a CTS frame before transmitting PPDU 2828 to AP 2810. AP 2810 may transmit a BA frame 2829 to STA 2811. In another embodiment, AP 2810 may not transmit a BA frame if an implicit ACK procedure is used.

In an embodiment, PPDU 2828 may be based on PPDU 2824. In an example, the data payload of PPDU 2828 may be the same as the data payload of PPDU 2824.

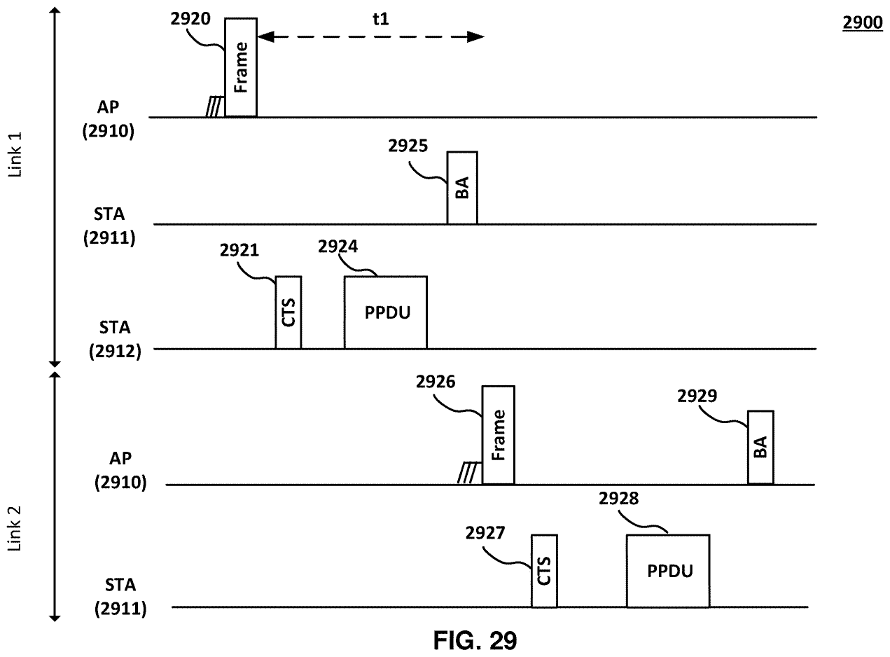

FIG. 29 illustrates an example 2900 of a multi-link relaying procedure, which may be used for relaying uplink traffic from a STA to an AP according to an embodiment. As shown in example 2900 may include an AP 2910 and plurality of STAs 2911 and 2912. In an example, STAs 2911 and 2912 may be associated with AP 2910. In an example, AP 2910, and STAs 2911 and 2912 may be within communication range of each other. In an example, AP 2910 may receive data frames from STA 2912 destined to itself. In another example, STA 2911 may serve as a relay for AP 2910. In an example, AP 2910 may prefer to transmission of a PPDU from STA 2912 via STA 2911 in order to increase the throughput in an uplink transmission. In an example, as shown in FIG. 29, AP 2910 and STAs 2911 and 2912 may communicate with each other via a first link (Link 1 in FIG. 29) and a second link (Link 2 in FIG. 29). The first and second link may correspond to different frequency bands (e.g., 2.4 GHz, 5 GHz, 60 GHz, etc.)

As shown in FIG. 29, the procedure may begin with AP 2910 transmitting a frame 2920 to STA 2912 via the first link. In an embodiment, frame 2920 may comprise a first field indicating relaying, from STA 2911 to AP 2910, of one or more frames received from STA 2912. In an embodiment, frame 2920 may further comprise a second field indicating the second link for the relaying of the one or more frames from STA 2911 to AP 2910.

In an embodiment, frame 2920 may be a multi-user request-to-send (MU-RTS) frame. In an implementation, the first field may be provided in a Common Info field of the MU-RTS frame. In an example, the first field may be provided in one of the reserved bits (e.g., B22, B26, B53 or B63) of the Common Info field illustrated in FIG. 17. In an implementation, the second field may be provided in a User Info List field of the MU-RTS frame. In an implementation, the second field may be provided in one or more of the reserved bits of the User Info List field illustrated in FIG. 16.

In another embodiment, frame 2920 may be an MRTT frame. An allocation of an MRTT frame may comprise an identifier of a STA, a time period (of the TXOP) allocated to the STA, and/or a TXS mode for the allocated time period. In example 2900, where frame 2920 is an MRTT frame, frame 2920 may comprise an allocation for STA 2912, which allocates a time period t1 to STA 2912 on the first link. In an implementation, the first field may be provided in a TXS mode subfield of the MRTT frame. The TXS mode subfield may be provided in a Common Info field of the MRTT frame. In an embodiment, the TXS mode subfield may be set to 3 to indicate downlink relaying. In an implementation, the first field may be provided in one of the reserved bits (e.g., B22, B26, B53 or B63) of the Common Info field illustrated in FIG. 17. In an implementation, the second field may be provided in a User Info List field of the MRTT frame. In an implementation, the second field may be provided in one or more of the reserved bits of the User Info List field illustrated in FIG. 16.

In example 2900, on receiving frame 2920, STA 2911 may determine that it is to receive, during the time period (t1) allocated to STA 2912 in MRTT frame 2920, a frame via the first link for relaying to AP 2910 via the second link. Frame 2920 may or may not comprise information regarding that the frame to be received via the first link will be received from STA 2912.

In an implementation, in response to frame 2920, STA 2912 may transmit a CTS frame 2921 to AP 2910. After transmission of CTS frame 2921, STA 2912 transmit a PPDU 2924 to STA 2911 via the first link. PPDU 2924 may comprise one or more frames. In response to PPDU 2924, STA 2911 may transmit a BA frame 2925 to STA 2912. In another embodiment, STA 2912 may not transmit a BA frame if an implicit ACK procedure is used.

In an implementation, on hearing BA frame 2925, AP 2910 may transmit to STA 2911 a frame 2926 via the second link. For example, frame 2926 may be transmitted a SIFS after AP 2910 receives BA frame 2925. In another implementation, AP 2910 may transmit frame 2926 a fixed period after transmission of frame 2920.

In an embodiment, frame 2926 may allocate to STA 2911 a time period for transmitting the one or more frames (contained in PPDU 2924) to AP 2910 via the second link. In an embodiment, the time period allocated to STA 2911 may be within a TXOP obtained by AP 2910 on the second link. In an implementation, frame 2926 may be an MRTT frame.

In another embodiment, frame 2926 may be an MU-RTS frame. The MU-RTS frame indicates a duration for transmission of the one or more frames from STA 2911 to AP 2910 via the second link.

In an implementation, STA 2911 may transmit a CTS frame 2927 in response to frame 2926, before transmitting a PPDU 2928 to AP 2910. PPDU 2928 may comprise the one or more frames (contained in PPDU 2924) received from STA 2912 via the first link. In another example, STA 2911 may not transmit a CTS frame before transmitting PPDU 2928 to AP 2910. AP 2910 may transmit a BA frame 2929 to STA 2911. In another embodiment, STA AP 2910 may not transmit a BA frame if an implicit ACK procedure is used.

In an embodiment, PPDU 2928 may be based on PPDU 2924. In an example, the data payload of PPDU 2928 may be the same as the data payload of PPDU 2924.

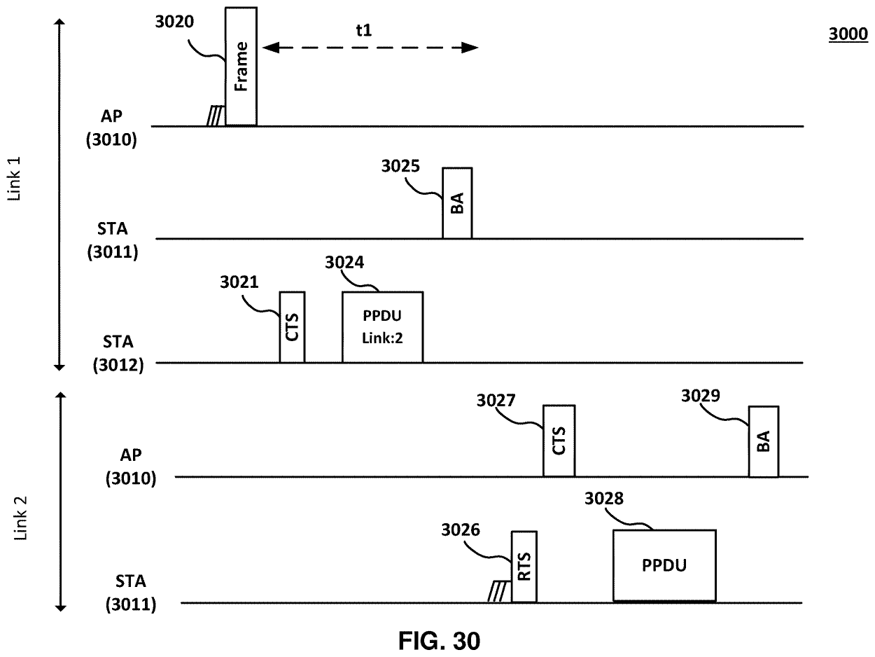

FIG. 30 illustrates an example 3000 of a multi-link relaying procedure, which may be used for relaying uplink traffic from a STA to an AP according to an embodiment. As shown in example 3000 may include an AP 3010 and plurality of STAs 3011 and 3012. In an example, STAs 3011 and 3012 may be associated with AP 3010. In an example, AP 3010, and STAs 3011 and 3012 may be within communication range of each other. In an example, AP 3010 may receive data frames from STA 3012 destined to itself. In another example, STA 3011 may serve as a relay for AP 3010. In an example, AP 3010 may prefer to transmission of a PPDU from STA 3012 via STA 3011 in order to increase the throughput in an uplink transmission. In an example, as shown in FIG. 30, AP 3010 and STAs 3011 and 3012 may communicate with each other via a first link (Link 1 in FIG. 30) and a second link (Link 2 in FIG. 30). The first and second link may correspond to different frequency bands (e.g., 2.4 GHz, 5 GHz, 60 GHz, etc.)

As shown in FIG. 30, the procedure may begin with AP 3010 transmitting a frame 3020 to STA 3012 via the first link. In an embodiment, frame 3020 may comprise a first field indicating relaying, from STA 3011 to AP 3010, of one or more frames received from STA 3012. In an embodiment, frame 3020 may further comprise a second field indicating the second link for the relaying of the one or more frames from STA 3011 to AP 3010.

In an embodiment, frame 3020 may be a multi-user request-to-send (MU-RTS) frame. In an implementation, the first field may be provided in a Common Info field of the MU-RTS frame. In an example, the first field may be provided in one of the reserved bits (e.g., B22, B26, B53 or B63) of the Common Info field illustrated in FIG. 17. In an implementation, the second field may be provided in a User Info List field of the MU-RTS frame. In an implementation, the second field may be provided in one or more of the reserved bits of the User Info List field illustrated in FIG. 16.

In another embodiment, frame 3020 may be an MRTT frame. An allocation of an MRTT frame may comprise an identifier of a STA, a time period (of the TXOP) allocated to the STA, and/or a TXS mode for the allocated time period. In example 3000, where frame 3020 is an MRTT frame, frame 3020 may comprise an allocation for STA 3012, which allocates a time period t1 to STA 3012 on the first link. In an implementation, the first field may be provided in a TXS mode subfield of the MRTT frame. The TXS mode subfield may be provided in a Common Info field of the MRTT frame. In an embodiment, the TXS mode subfield may be set to 3 to indicate relaying. In an implementation, the first field may be provided in one of the reserved bits (e.g., B22, B26, B53 or B63) of the Common Info field illustrated in FIG. 17. In an implementation, the second field may be provided in a User Info List field of the MRTT frame. In an implementation, the second field may be provided in one or more of the reserved bits of the User Info List field illustrated in FIG. 16.

In an implementation, in response to frame 3020, STA 3012 may transmit a CTS frame 3021 to AP 3010. After transmission of CTS frame 3021, STA 3012 may transmit a PPDU 3024 to STA 3011 via the first link. In an embodiment, PPDU 3024 may comprise a first field indicating relaying, by STA 3011 to AP 3010, of one or more frames comprised in PPDU 3024. In an embodiment, PPDU 3024 may further comprise a second field indicating the second link for the relaying of the one or more frames from STA 3011 to STA 3012.

In an embodiment, the first field of PPDU 3024 may comprise a portion of a physical layer (PHY) header or a portion of a medium access control (MAC) header comprised in PPDU 3024. In an embodiment, the second field may comprise a portion of a physical layer (PHY) header and a portion of a medium access control (MAC) header comprised in PPDU 3024.

In an embodiment, as described above in FIG. 30, the PPDU 3024 from the STA 3012 may comprise a PHY header comprising a receiver address (RA) and a destination address (DA) of the PPDU. In an embodiment, as described above in FIG. 30, PPDU 3024 may comprise a PHY header comprising a flag indicating multi-link relaying and an RA of the PPDU. In an embodiment, as described above in FIG. 30, the PPDU 3024 may comprise a PHY header comprising a flag for multi-link relaying. In an embodiment, the PHY header may be a PHY header of an Extremely High Throughput (EHT) multi-user (MU) PPDU. EHT MU PPDU may comprise a PHY header, where PHY header may comprise non-high throughput (non-HT) signal field (L-SIG), repeated L-SIG (RL-SIG), universal signal field (U-SIG) and EHT signal field (EHT-SIG). EHT-SIG may further comprise a common field and a user specific field. User specific field may comprise multiple user fields to include RA and DA. In addition, indication for multi-link relaying may be signaled in the user specific field, if it is used in the procedure. User specific field may comprise the second field indicating the second link for the relaying.

In an embodiment, as described above in FIG. 30, the PPDU 3024 may comprise a MAC header comprising a receiver address (RA) and a destination address (DA) of a data unit of the PPDU 3024. In an embodiment, as described above in FIG. 30, the indication for multi-link relaying (e.g., first field) may be signaled in an HT control field of the MAC header. HT Control field may comprise the second field indicating the second link for the relaying.

In response to PPDU 3024, STA 3011 may transmit a BA frame 3025 to STA 3012. In another embodiment, STA 3012 may not transmit a BA frame if an implicit ACK procedure is used.

In an implementation, STA 3011 may transmit an RTS frame 3026 via the second link after reception of PPDU 3024.

In an implementation, AP 3010 may transmit a CTS frame 3027 in response to RTS frame 3026. After receiving CTS frame 3027, STA 3011 may transmit a PPDU 3028 to AP 3010. PPDU 3028 may comprise the one or more frames (contained in PPDU 3024) received from STA 3012 via the first link. In another example, AP 3010 may not transmit a CTS frame before receiving PPDU 3028. AP 3010 may transmit a BA frame 3029 to STA 3011. In another embodiment, AP 3010 may not transmit a BA frame if an implicit ACK procedure is used.

In an embodiment, PPDU 3028 may be based on PPDU 3024. In an example, the data payload of PPDU 3028 may be the same as the data payload of PPDU 3024.

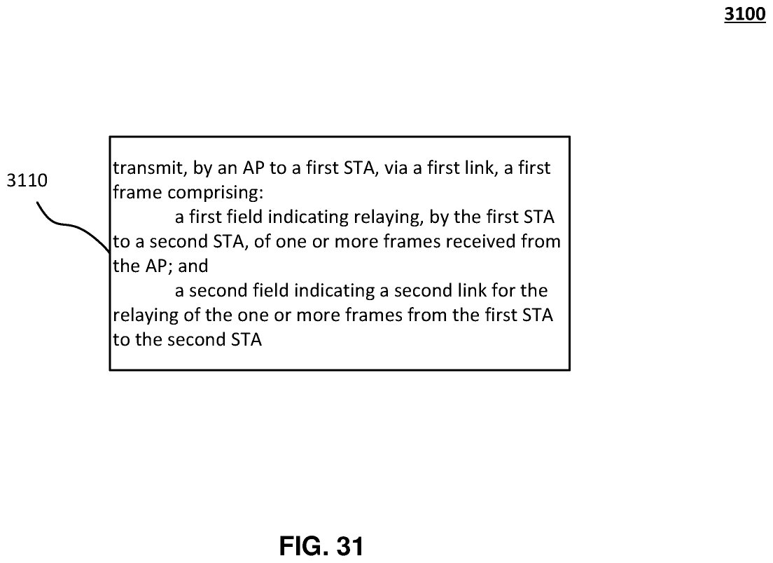

FIG. 31 illustrates an example process 3100 according to an embodiment. Example process 3100 is provided for the purpose of illustration only and is not limiting. Example process 3100 may be performed by an AP, such as AP 2310, for example, in the context of a relaying procedure.

As shown in FIG. 31, process 3100 may include, in step 3110, transmitting, by the AP to a first STA, via a first link, a first frame comprising, a first field indicating relaying, by the first STA to a second STA, of one or more frames received from the AP; and a second field indicating a second link for the relaying of the one or more frames from the first STA to the second STA.

In an embodiment, process 3100 may further comprising transmitting, by the AP to the first STA, the one or more frames via the first link.

In an embodiment, the first frame may comprise a multi-user request-to-send (MU-RTS) frame. In an implementation, the first field is provided in a Common Info field of the MU-RTS frame. In an implementation, the second field is provided in a User Info list field of the MU-RTS frame.

In another embodiment, the first frame may comprise a multi-user request-to-send triggered TXOP sharing (MU-RTS TXS) trigger (MRTT) frame. In an implementation, the first field is provided in a TXS mode subfield of the MRTT frame. In an implementation, the first field may be provided in a TXS mode subfield of the MRTT frame. The TXS mode subfield may be provided in a Common Info field of the MRTT frame. In an embodiment, the TXS mode subfield may be set to 3 to indicate relaying. In an implementation, the first field may be provided in one of the reserved bits (e.g., B22, B26, B53 or B63) of the Common Info field illustrated in FIG. 17.

In an implementation, the second field may be provided in a User Info List field of the MRTT frame. In an implementation, the second field may be provided in one or more of the reserved bits of the User Info List field illustrated in FIG. 16.

In an embodiment, process 3100 may further comprising transmitting, by the AP to the first STA, via the second link, a second frame allocating to the first STA a time period for transmitting the one or more frames to the second STA via the second link.

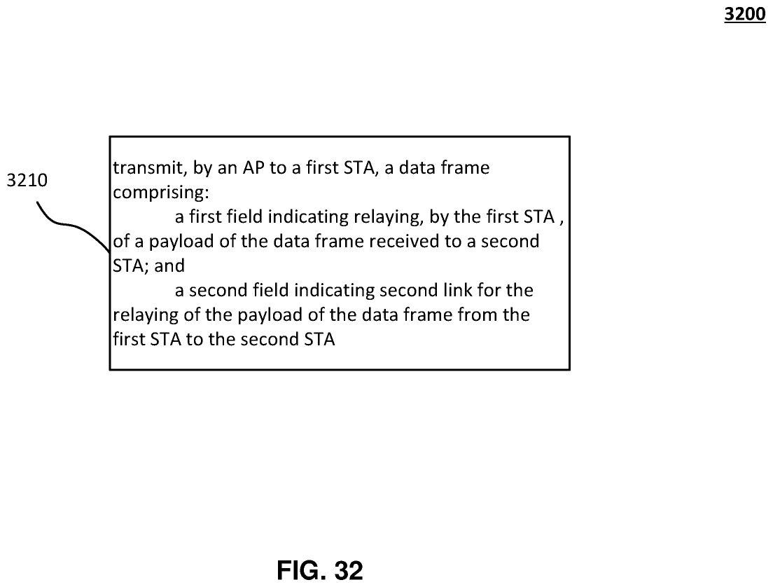

FIG. 32 illustrates an example process 3200 according to an embodiment. Example process 3200 is provided for the purpose of illustration only and is not limiting. Example process 3200 may be performed by an AP, such as AP 2710, for example, in the context of a relaying procedure.

As shown in FIG. 32, process 3200 may include, in step 3210, transmitting, by an AP to a first STA, a data frame comprising, a first field indicating relaying, by the first STA, of a payload of the data frame received to a second STA and a second field indicating a second link for the relaying of the payload of the data frame from the first STA to the second STA.

In an embodiment, the data frame may be a PPDU.

In an embodiment, the first field may comprise a portion of a physical layer (PHY) header of the frame or a portion of a medium access control (MAC) header comprised of the frame.

In an embodiment, the second field comprises a portion of a physical layer (PHY) header of the frame and a portion of a medium access control (MAC) header comprised of the frame.

In an embodiment, process 3200 may further comprise transmitting, by the AP to the first STA, a request to send (RTS) frame and receiving, by the AP from the first STA, a clear to send (CTS) frame.

In an embodiment, process 3200 may further comprise transmitting the data frame in response to receiving the CTS frame.

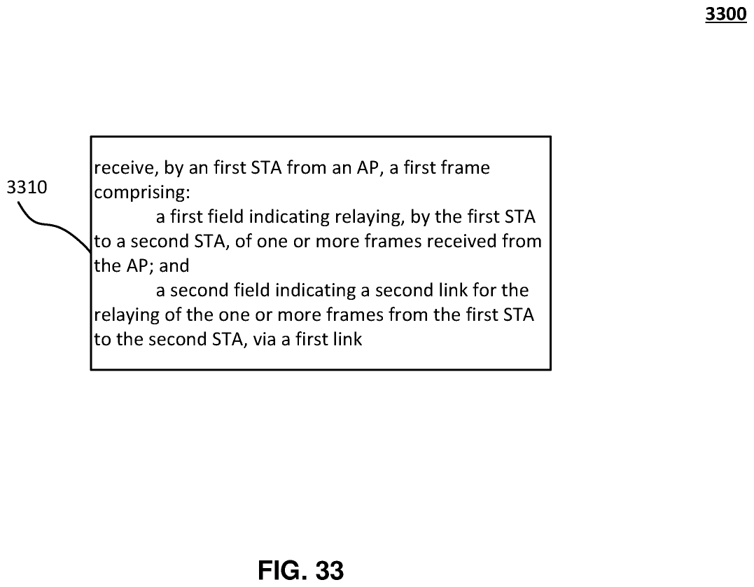

FIG. 33 illustrates an example process 3300 according to an embodiment. Example process 3300 is provided for the purpose of illustration only and is not limiting. Example process 3300 may be performed by a first STA, such as STA 2711, for example, in the context of a relaying procedure.

As shown in FIG. 33, process 3300 may include, in step 3310, receiving, by the first STA from an AP, via a first link, a first frame comprising: a first field indicating relaying, by the first STA to a second STA, of one or more frames received from the AP; and a second field indicating a second link for the relaying of the one or more frames from the first STA to the second STA.

In an embodiment, process 3300 may further comprise receiving, by the first STA from the AP, the one or more frames via the first link.

In an embodiment, the first frame may comprise a multi-user request-to-send (MU-RTS) frame. In an implementation, the first field is provided in a Common Info field of the MU-RTS frame. In an implementation, the second field is provided in a User Info list field of the MU-RTS frame.

In another embodiment, the first frame may comprise a multi-user request-to-send triggered TXOP sharing (MU-RTS TXS) trigger (MRTT) frame. In an implementation, the first field is provided in a TXS mode subfield of the MRTT frame. In an implementation, the first field may be provided in a TXS mode subfield of the MRTT frame. The TXS mode subfield may be provided in a Common Info field of the MRTT frame. In an embodiment, the TXS mode subfield may be set to 3 to indicate relaying. In an implementation, the first field may be provided in one of the reserved bits (e.g., B22,B26, B53 or B63) of the Common Info field illustrated in FIG. 17.

In an implementation, the second field may be provided in a User Info List field of the MRTT frame. In an implementation, the second field may be provided in one or more of the reserved bits of the User Info List field illustrated in FIG. 16.

In an embodiment, process 3300 may further comprise receiving, by the STA from the first AP, via the second link, a second frame allocating to the first STA a time period for transmitting the one or more frames to the second STA via the second link.

In an embodiment, process 3300 may further comprise transmitting, by the first STA to the second STA, one or more frames via the second link.

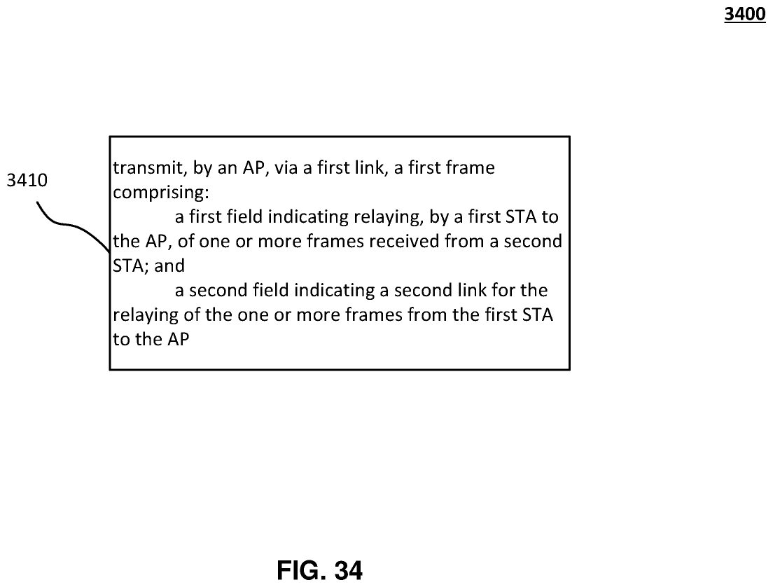

FIG. 34 illustrates an example process 3400 according to an embodiment. Example process 3400 is provided for the purpose of illustration only and is not limiting. Example process 3400 may be performed by an AP, such as AP 2810, for example, in the context of a relaying procedure.

As shown in FIG. 34, process 3400 may include, in step 3410, transmitting, by an AP, via a first link, a first frame comprising, a first field indicating relaying, by a first STA to the AP, of one or more frames received from a second STA; and a second field indicating a second link for the relaying of the one or more frames from the first STA to the AP.

In an embodiment, process 3400 may further comprise receiving, by the AP from the first STA, the one or more frames via the second link.

In an embodiment, process 3400 may further comprise receiving, by the AP from the first STA, a clear to send (CTS) frame via the first link.

In an embodiment, the first frame may comprise a multi-user request-to-send (MU-RTS) frame. In an implementation, the first field is provided in a Common Info field of the MU-RTS frame. In an implementation, the second field is provided in a User Info list field of the MU-RTS frame.

In another embodiment, the first frame may comprise a multi-user request-to-send triggered TXOP sharing (MU-RTS TXS) trigger (MRTT) frame. In an implementation, the first field is provided in a TXS mode subfield of the MRTT frame. In an implementation, the first field may be provided in a TXS mode subfield of the MRTT frame. The TXS mode subfield may be provided in a Common Info field of the MRTT frame. In an embodiment, the TXS mode subfield may be set to 3 to indicate relaying. In an implementation, the first field may be provided in one of the reserved bits (e.g., B22, B26, B53 or B63) of the Common Info field illustrated in FIG. 17.

In an implementation, the second field may be provided in a User Info List field of the MRTT frame. In an implementation, the second field may be provided in one or more of the reserved bits of the User Info List field illustrated in FIG. 16. In an embodiment, process 3400 may further comprising transmitting, by the AP to the first STA, via the second link, a second frame allocating to the first STA a time period for transmitting the one or more frames to the AP via the second link.

In an embodiment, process 3400 may further comprise transmitting, by the first STA to the AP, one or more frames via the second link.

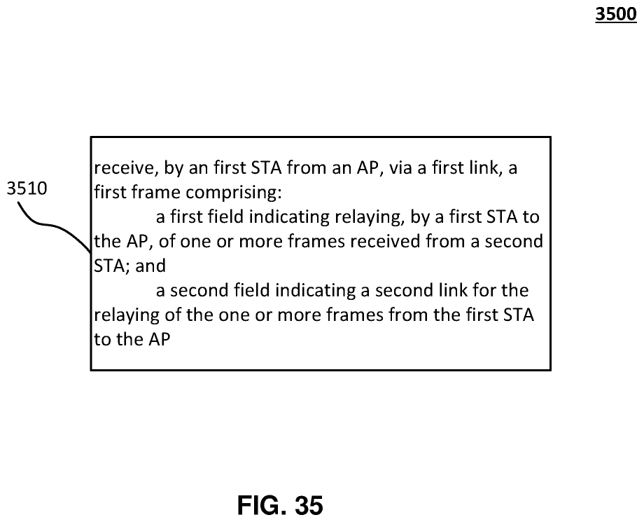

FIG. 35 illustrates an example process 3500 according to an embodiment. Example process 3500 is provided for the purpose of illustration only and is not limiting. Example process 3500 may be performed by a first STA, such as STA 2811, for example, in the context of a relaying procedure.

As shown in FIG. 35, process 3500 may include, in step 3510, receiving, by the first STA from an AP, via a first link, a first frame comprising: a first field indicating relaying, by the first STA to the AP, of one or more frames received from a second STA; and a second field indicating a second link for the relaying of the one or more frames from the first STA to the AP.

In an embodiment, process 3500 may further comprise transmitting, by the first STA to the AP, clear to send (CTS) frame via the first link.

In an embodiment, process 3500 may further comprise receiving, by the first STA from the second STA, the one or more frames via the first link.

In an embodiment, the first frame may comprise a multi-user request-to-send (MU-RTS) frame. In an implementation, the first field is provided in a Common Info field of the MU-RTS frame. In an implementation, the second field is provided in a User Info list field of the MU-RTS frame. In another embodiment, the first frame may comprise a multi-user request-to-send triggered TXOP sharing (MU-RTS TXS) trigger (MRTT) frame. In an implementation, the first field is provided in a TXS mode subfield of the MRTT frame. In an implementation, the first field may be provided in a TXS mode subfield of the MRTT frame. The TXS mode subfield may be provided in a Common Info field of the MRTT frame. In an embodiment, the TXS mode subfield may be set to 3 to indicate relaying. In an implementation, the first field may be provided in one of the reserved bits (e.g., B22, B26, B53 or B63) of the Common Info field illustrated in FIG. 17.

In an implementation, the second field may be provided in a User Info List field of the MRTT frame. In an implementation, the second field may be provided in one or more of the reserved bits of the User Info List field illustrated in FIG. 16.

In an embodiment, process 3500 may further comprise receiving, by the first STA from the AP, via the second link, a second frame allocating to the first STA a time period for transmitting the one or more frames to the second STA via the second link.

In an embodiment, process 3500 may further comprise transmitting, by the first STA to the AP, the one or more frames via the second link.

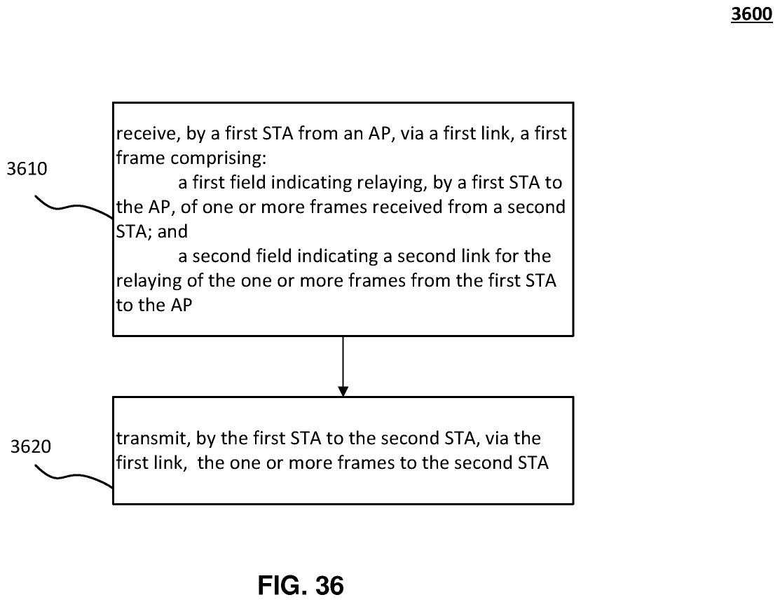

FIG. 36 illustrates an example process 3600 according to an embodiment. Example process 3600 is provided for the purpose of illustration only and is not limiting. Example process 3600 may be performed by a first STA, such as STA 3012, for example, in the context of a relaying procedure.

As shown in FIG. 36, process 3600 may include, in step 3610, receiving, by the first STA from an AP, via a first link, a first frame comprising: a first field indicating relaying, by a second STA to the AP, of one or more frames received from the first STA; and a second field indicating a second link for the relaying of the one or more frames from the second STA to the AP.

In an embodiment, the first frame may comprise a multi-user request-to-send (MU-RTS) frame. In an implementation, the first field is provided in a Common Info field of the MU-RTS frame. In an implementation, the second field is provided in a User Info list field of the MU-RTS frame.

In another embodiment, the first frame may comprise a multi-user request-to-send triggered TXOP sharing (MU-RTS TXS) trigger (MRTT) frame. In an implementation, the first field is provided in a TXS mode subfield of the MRTT frame. In an implementation, the first field may be provided in a TXS mode subfield of the MRTT frame. The TXS mode subfield may be provided in a Common Info field of the MRTT frame. In an embodiment, the TXS mode subfield may be set to 3 to indicate relaying. In an implementation, the first field may be provided in one of the reserved bits (e.g., B22, B26, B53 or B63) of the Common Info field illustrated in FIG. 17.

In an implementation, the second field may be provided in a User Info List field of the MRTT frame. In an implementation, the second field may be provided in one or more of the reserved bits of the User Info List field illustrated in FIG. 16. In an embodiment, process 3600 may further comprise transmitting by the STA to the AP, clear to send frame via the first link.

In an embodiment, process 3600 may further comprise, in step 3610, transmitting, by the first STA to the AP, clear to send (CTS) frame via the first link.

In an embodiment, process 3600 may include, in step 3620, transmitting, by the first STA to the second STA, via the first link, the one or more frames to the second STA.

The one or more frames in step 3620 comprise a third field indicating relaying, by the second STA to the AP, of one or more frames received from the first STA; and a fourth field indicating the second link for the relaying of the one or more frames from the second STA to the AP.

In an embodiment, the third field may comprise a portion of a physical layer (PHY) header of the frame or a portion of a medium access control (MAC) header comprised of the frame.

In an embodiment, the fourth field comprises a portion of a physical layer (PHY) header of the frame and a portion of a medium access control (MAC) header comprised of the frame.

What is claimed is:

1. An access point (AP) comprising:
one or more processors; and
memory storing instructions that, when executed by the one or more processors, cause the AP to:
transmit, to a first station (STA) via a first link, a first frame indicating:
transmission, by the first STA to a second STA, of one or more frames; and
a second link for transmission of the one or more frames from the first STA to the second STA.

2. The AP of claim 1, wherein the first link and the second link correspond to different frequency bands.

3. The AP of claim 2, wherein the first link corresponds to a 2.4 GHz frequency band, a 5 GHz frequency band, or a 6 GHz frequency band.

4. The AP of claim 3, wherein the second link corresponds to a 60 GHz frequency band.

5. The AP of claim 4, further comprising:
transmitting, by the AP to the second STA via a third link, a second frame indicating the second link for transmission of the one or more frames from the first STA to the second STA.

6. The AP of claim 5, wherein the third link and the second link correspond to different frequency bands.

7. The AP of claim 6, wherein the third link corresponds to a 2.4 GHz frequency band, a 5 GHz frequency band, or a 6 GHz frequency band.

8. A first station (STA) comprising:
one or more processors; and
memory storing instructions that, when executed by the one or more processors, cause the first STA to:
receive, from an access point (AP) via a first link, a first frame indicating:
transmission, by the first STA to a second STA, of one or more frames; and
a second link for transmission of the one or more frames from the first STA to the second STA.

9. The first STA of claim 8, wherein the first link and the second link correspond to different frequency bands.

10. The first STA of claim 9, wherein the first link corresponds to a 2.4 GHz frequency band, a 5 GHz frequency band, or a 6 GHz frequency band.

11. The first STA of claim 10, wherein the second link corresponds to a 60 GHz frequency band.

12. The first STA of claim 11, further comprising: transmitting, by the first STA to the second STA via the second link, the one or more frames.

13. The first STA of claim 12, wherein the first STA transmits the first one or more frames to the second STA via the second link based on the first frame.

14. The first STA of claim 13, further comprising: receiving, by the first STA form the second STA via the second link, a second one or more frames.

15. A non-transitory computer-readable medium comprising instructions that, when executed by one or more processors of an access point (AP), cause the AP to:
transmit, to a first station (STA) via a first link, a first frame indicating:
transmission, by the first STA to a second STA, of one or more frames; and
a second link for transmission of the one or more frames from the first STA to the second STA.

16. The non-transitory computer-readable medium of claim 15, wherein the first link and the second link correspond to different frequency bands.

17. The non-transitory computer-readable medium of claim 16, wherein the first link corresponds to a 2.4 GHz frequency band, a 5 GHz frequency band, or a 6 GHz frequency band.

18. The non-transitory computer-readable medium of claim 17, wherein the second link corresponds to a 60 GHz frequency band.

19. The non-transitory computer-readable medium of claim 18, further comprising:
transmitting, by the AP to the second STA via a third link, a second frame indicating the second link for transmission of the one or more frames from the first STA to the second STA.

20. The non-transitory computer-readable medium of claim 19, wherein the third link and the second link correspond to different frequency bands, and wherein the third link corresponds to a 2.4 GHz frequency band, a 5 GHz frequency band, or a 6 GHz frequency band.
